(19) United States
(12) Patent Application Publication
(10) Pub. No.: US 2019/0185382 A1
(43) Pub. Date: Jun. 20, 2019

(54) CERAMIC-POLYMER COMPOSITES OBTAINED BY A COLD SINTERING PROCESS

(71) Applicant: SABIC-GAPT, Houston, TX (US)

(72) Inventors: Anne Bolvari, West Chester, PA (US); Theodorus Hoeks, Bergen op Zoom (NL); Ranjan Dash, Royersford, PA (US); Thomas L. Evans, Mount Vernon, IN (US); Neal Pfeiffenberger, Conshohocken, PA (US); Jonathan Bock, Albuquerque, NM (US); Chiel Albertus Leenders, Fijnaart (NL); Mark John Armstrong, Bergen op Zoom (NL)

(21) Appl. No.: 16/327,621

(22) PCT Filed: Aug. 25, 2017
(86) PCT No.: PCT/US2017/048735

§ 371 Date: Feb. 22, 2019

Related U.S. Application Data
(60) Provisional application No. 62/379,851, filed on Aug. 26, 2016.

(51) Int. Cl. C04B 35/645; C04B 35/495; C04B 35/453; C04B 35/634; C04B 35/626

(52) U.S. Cl. CPC C04B 35/645; C04B 35/495; C04B 35/453; C04B 35/63408; C04B 35/63464; C04B 35/63488; C04B 2235/662; C04B 35/6269; C04B 2235/3256; C04B 2235/3284; C04B 2235/48; C04B 2235/5436; C04B 2235/656; C04B 35/6264

(57) ABSTRACT

Described herein are cold-sintered ceramic polymer composites and processes for making them from inorganic compound starting materials and polymers. The cold sintering process and wide variety of polymers permit the incorporation of diverse polymeric materials into the ceramic.

This application claims the benefit of priority to U.S. Provisional Patent Application No. 62/379,851, filed on Aug. 26, 2016, which application is incorporated in its entirety as if fully set forth herein.

### BACKGROUND

Many ceramic and composite materials are sintered to reduce porosity and to enhance properties of the materials such as strength, electrical conductivity, translucency and thermal conductivity. Sintering processes involve the application of high temperatures, typically above 1,000° C., to densify and to improve the properties of the materials. However, the use of high sintering temperatures precludes the fabrication of certain types of materials and it increases the expense of fabricating the materials.

Conventional manufacturing of ceramic parts requires the heating of a pressed ceramic material at high temperatures, typically at 0.6-0.7 times of the melting temperature. Because many non-ceramic materials have lower melting temperatures than ceramics, the high temperature requirement of conventional sintering process does not allow the incorporation of non-ceramic materials within ceramic matrix during the sintering process. Further, non-ceramic materials can degrade when exposed to high temperature or other conditions currently employed in the conventional sintering process.

It is difficult to manufacture ceramic parts of complicated shapes or near finished shapes using conventional sintering processes. Also, it is difficult to make ceramics parts with high dimensional tolerances using conventional sintering process. The high temperature of conventional sintering process leads to volumetric changes of ceramic materials, thereby making it difficult to control the dimensions of sintered parts.

The use of high temperature in conventional sintering processes also can result in by-products that need material handling systems for efficient capture and safe disposal.

Using conventional techniques, it is difficult to manufacture ceramics parts that have large amounts of grain boundaries. The high temperature of conventional sintering processes moreover result in the formation of large grains and thereby reduce the number of grain boundaries.

Certain low temperature processes for sintering ceramics can address some of the challenges related to high temperature sintering. For example, Ultra Low Temperature Cofired Ceramics (ULTCC) can be fired between 450° C. and 750° C. See, e.g., He et al., “Low-Temperature Sintering Li₂MoO₄/Ni_{0.5}Zn_{0.5}Fe₂O₄ Magneto-Dielectric Composites for High-Frequency Application,” J. Am. Ceram. Soc. 2014:97(8):1-5. In addition, the dielectric properties of Li₂MoO₄ can be improved by moistening water-soluble Li₂MoO₄ powder, compressing it, and post processing the resulting samples at 120° C. See Kahari et al., J. Am. Ceram. Soc. 2015:98(3):687-689. Even so, while the particle size of Li₂MoO₄ powder was less than 180 microns, Kahari teaches that smaller particle sizes complicates the even moistening of the powder, thereby resulting in clay-like clusters, non-uniform density, warpage and cracking, and ultimately concluding that a large particle size is advantageous.

### SUMMARY

The present invention addresses these and other challenges by providing cold-sintered ceramic polymer composites and processes for making them. The process enables a large variety of ceramic polymer composites to be produced through sintering steps occurring at low temperatures and modest pressures.

Thus, in one embodiment, the invention provides a cold-sintered ceramic polymer composite that is made by a process comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite.

The polymer has a melting point (Tₘ), if the polymer is crystalline or semi-crystalline, or a glass transition temperature (T_{g}), if the polymer is amorphous, that is less than T₁. In some embodiments, notwithstanding these features, the polymer is not polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion).

In another embodiment, the invention provides a cold-sintered ceramic polymer composite that is made by a process comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite.

In this embodiment, the polymer has a melting point (Tₘ), if the polymer is crystalline or semi-crystalline, or a glass transition temperature (T_{g}), if the polymer is amorphous, that is less than T₁. Further, the polymer is a branched polymer.

Another embodiment is a process for making a cold-sintered ceramic polymer composite, comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite.

In the inventive process, the polymer has a melting point (Tₘ), if the polymer is crystalline or semi-crystalline, or a glass transition temperature (T_{g}), if the polymer is amorphous, that is less than T₁. In some embodiments, the polymer is not polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion).

Alternatively, according to another embodiment, the invention provides a process for making a cold-sintered ceramic polymer composite, comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite.

In this embodiment, the polymer has a melting point (Tₘ), if the polymer is crystalline or semi-crystalline, or a glass transition temperature (T_{g}), if the polymer is amorphous, that is less than T₁. Further, the polymer is a branched polymer.

Also contemplated in various embodiments is a cold-sintered ceramic polymer composite that is produced by any of the processes that are described herein. The cold-sintering steps of the processes can result in the densification of the inorganic compound. Thus, according to some embodiments, the cold-sintered ceramic polymer composite, or the cold-sintered ceramic, exhibits a relative density of at least 70% as determined by mass/geometry ratio, the Archimedes method, or an equivalent method. The relative density can be at least 75%, 80%, 85%, 90%, or 95%.

### DETAILED DESCRIPTION

Briefly, the Archimedes method was employed to determine the density of samples using a KERN ABS-N/ABJ-NM balance equipped with an ACS-A03 density determination set. Dried samples (e.g., pellets) were first weighed (W_{dry}) and subjected to boiling in 2-propanol for a period of 1 h. The samples were then suspended in 2-propanol at a known temperature to determine the apparent mass in liquid (Wₛᵤₛ), removed, and the excess liquid wiped from the surface of the sample using a tissue moistened with 2-propanol. The saturated sample were then immediately weighed in air (Wₛₐₜ). The density is then determined by:

Density=W_{dry}/(Wₛₐₜ−Wₛᵤₛ)*density of solvent

where the density of 2-propanol was taken to be 0.786 g/cm³ at 20° C., 0.785 g/cm³ at 21° C., and 0.784 g/cm³ at 22° C.

The geometric method for determining density, also known as the “geometric (volume) method,” involves measuring the diameter (D) and thickness (t) of cylindrical samples using, e.g., a digital caliper. The volume of a cylinder can be calculated from the formula V=π(D/2)²×t. The mass of the cylindrical sample was measured with an analytical balance. The relative density was determined by dividing the mass by the volume.

The volume method is comparable to Archimedes method for simple geometries, such as cubes, cuboids and cylinders, in which it is relatively easy to measure the volume. For samples with highly irregular geometry, accurately measuring the volume may be difficult, in which case the Archimedes method may be more appropriate to measure density.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The invention provides a cold-sintered ceramic polymer composite that is obtained by any of the processes described herein, any one of which is referred to as a Cold Sintering Process (CSP). The sintering processes described herein relate to the thermo-chemical processing of a mixture of ceramic and non-ceramic constituents at low temperatures, compared to those required for traditional ceramic sintering, in acidic, basic or neutral chemical environments. The CSP includes the presence of one or more solvents that has some degree of reactivity with, or ability to at least partially dissolve, the inorganic compound(s) that are the pre-ceramic materials. Low sintering temperatures of the CSP enables the incorporation of non-ceramic materials prior to the sintering process, which incorporation is either impossible or difficult to achieve in conventional high temperature sintering process. The incorporation of non-ceramic components within the sintered ceramic matrix provides several features that are not typical of ceramics, including electrical conductivity, thermal conductivity, flexibility, resistance to crack propagation, different wear performance, different dielectric constant, improved electrical breakdown strength, and/or improved mechanical toughness.

In an inventive process, one or more inorganic compounds in particulate form is combined with at least a solvent and at least one polymer (P₁). Without wishing to be bound by any particular theory of operation, the inventor believe that the inorganic compound reacts with or partially dissolves in the solvent to form a solid solution at the surface of particles of the inorganic compounds. In an exemplary embodiment, the mixture of inorganic compound, solvent, and polymer is placed into a mold and subjected to pressure and elevated temperature, typically of no more than about 5000 MPa and a temperature (T₁) that is no greater than 200° C. above the boiling point of the solvent (as determined at 1 bar). The presence of a solid solution along with applied pressure and temperature allows the inorganic compound to sinter.

It is possible that dissolution of sharp edges of the solid particles reduces the interfacial areas, and some capillary forces helps the rearrangement in the initial stage of sintering. Upon the application of external and capillary pressures, the liquid phase redistributes itself and fills into the pores between the particles. Because of the pressure-assisted flowing of the liquid, solid particles can rearrange rapidly, which collectively leads to densification. A subsequent stage, often referred to as “solution-precipitation”, is created through the liquid evaporation that enables a supersaturated state of the liquid phase at a low temperatures, triggering a large chemical driving force for the solid and liquid phases to reach the equilibrium state.

Under the externally applied and capillarity pressure, the contact areas between particles have a higher chemical potential, so that in this stage, ionic species and/or atomic clusters diffuse through the liquid and precipitate on the particles at sites away from the contact areas. The mass transport during this process minimizes excess free energy of the surface area and removes the porosity as the material forms a dense solid. Owing to the fixed shape of the hot-pressing die, the particles will shrink and be flattened predominantly in the direction of the external pressure.

In the final stage of sintering, with the evaporation of most of the water, the areas of solid-solid contacts increase, leading to the formation of a rigid solid particulate skeletal network, which reduces the densification rate. Meanwhile, a nanometer thick amorphous phase can be produced in some grain boundary areas, thereby suppressing the grain boundary diffusion activity. However, the grain shape accommodation will slowly eliminate the porosity, aiding further densification in this stage. Non-ceramic components such as the polymer (P₁) remains inside the ceramic matrix during this CSP, thereby resulting in the cold-sintered ceramic polymer composite. A well dispersed polymer (P₁) within the ceramic thus enjoys improved interactions between the ceramic and the polymer resulting in enhanced fracture toughness, improved tribological properties, better scratch performance, better thermal conductivity, and better electrical properties than a sintered ceramic without the polymer.

### Inorganic Compounds

Various embodiments of the processes described herein employ at least one inorganic compound that is in the form of particles. Useful inorganic compounds include, without limitation, metal oxides, metal carbonates, metal sulfates, metal sulfides, metal selenides, metal tellurides, metal arsenides, metal alkoxides, metal carbides, metal nitrides, metal halides (e.g., fluorides, bromides, chlorides, and iodides), clays, ceramics glasses, metals, and combinations thereof. Specific examples of inorganic compounds include MoO₃, WO₃, V₂O₃, V₂O₅, ZnO,Bi₂O₃, CsBr, Li₂CO₃, CsSO₄, Li₂MoO₄, Na₂Mo₂O₇, K₂Mo₂O₇, ZnMoO₄, Gd₂(MoO₄)₃, Li₂WO₄, Na₂WO₄, LiVO₃, BiVO₄, AgVO₃, Na₂ZrO₃, LiFePO₄, and KH₂PO₄. In other embodiments, precursor metal salts can be used in the form of solutions to aid or otherwise facilitate the cold-sintering process. For example, water-soluble zinc (II) salts such as zinc chloride and zinc acetate deposit water-insoluble ZnO on an existing inorganic surface. In this manner, precipitation of ZnO from the precursor solution thermodynamically favors the progression of the cold-sintering process.

In some embodiments, the inventive processes use mixtures of inorganic compounds that, upon sintering, react with each other to provide a sintered ceramic material (solid state reactive sintering). One advantage of this approach is the reliance upon comparatively inexpensive inorganic compound starting materials. Additional advantages of solid-state reactive sintering (SSRS) method includes the simplified fabrication process for proton conducting ceramics by combining phase formation, densification, and grain growth into one sintering step. See S. Nikodemski et al., Solid State Ionics 253 (2013) 201-210. One example of reactive inorganic compounds relates to the sintering of Cu₂S and in²S₃ to yield stoichiometric CuInS₂—See T. Miyauchi et al., Japanese Journal of Applied Physics, vol. 27, Part 2, No. 7, L1178. Another example is the addition of NiO to Y₂O₃, ZrO₂, and BaCO₃ to yield BaY₂NiO₅ upon sintering. See J. Tong, J. Mater. Chem. 20 (2010) 6333-6341.

The inorganic compound is present in the form of particles, such as a fine powder. Any conventional method for producing a particulate form of the inorganic compound is suitable. For example, the particles can result from various milling processes, such as ball milling, attrition milling, vibratory milling, and jet milling.

The resultant particle size, i.e., diameter, of the inorganic compound is about 100 μm or less, based on the particle number average. In various embodiments, the average number particle size is less than about 90 μm, less than about 80 μm, less than about 70 μm, less than about 60 μm, less than about 50 μm, less than about 40 μm, less than about 30 μm, less than about 20 μm, or less than about 10 μm. Any suitable method can be used to measure particle size and distribution, such as laser scattering. In illustrative embodiments, at least 80%, at least 85%, at least 90%, or at least 95% of the particles by number have a size that is less than the stated number average particle size.

According to some embodiments of the invention, the inorganic compound is combined with a solvent to obtain a mixture. In other embodiments, the inorganic compound is combined with a solvent, and at least one monomer, reactive oligomer, or combination thereof to obtain a mixture. In these embodiments, the inorganic compound is present in about 50 to about 95 wt %, based upon the total weight of the mixture. Exemplary weight percentages of the inorganic compound in the mixture are at least 50%, at least 55%, at least 60%, at least 65%, at least 70%, at least 75%, at least 80%, at least 85%, and at least 90%.

### Solvents

The processes of the invention employ at least one solvent in which the inorganic compound has at least partial solubility. Useful solvents include water, an alcohol such as a C₁₋₆-alkyl alcohol, an ester, a ketone, dipolar aprotic solvents (e.g. dimethylsulfoxide (DMSO), N-methyl-2-pyrrolidone (NMP), and dimethylformamide (DMF)), and combinations thereof. In some embodiments, only a single solvent is used. In other embodiments, mixtures of two or more solvents are used.

Still other embodiments provide for aqueous solvent systems to which one or more other components are added for adjusting pH. The components include inorganic and organic acids, and organic and inorganic bases.

Examples of inorganic acids include sulfurous acid, sulfuric acid, hyposulfurous acid, persulfuric acid, pyrosulfuric acid, disulfurous acid, dithionous acid, tetrathionic acid, thiosulfurous acid, hydrosulfuric acid, peroxydisulfuric acid, perchloric acid, hydrochloric acid, hypochlorous acid, chlorous acid, chloric acid, hyponitrous acid, nitrous acid, nitric acid, pernitric acid, carbonous acid, carbonic acid, hypocarbonous acid, percarbonic acid, oxalic acid, acetic acid, phosphoric acid, phosphorous acid, hypophosphous acid, perphosphoric acid, hypophosphoric acid, pyrophosphoric acid, hydrophosphoric acid, hydrobromic acid, bromous acid, bromic acid, hypobromous acid, hypoiodous acid, iodous acid, iodic acid, periodic acid, hydroiodic acid, fluorous acid, fluoric acid, hypofluorous acid, perfluoric acid, hydrofluoric acid, chromic acid, chromous acid, hypochromous acid, perchromic acid, hydroselenic acid, selenic acid, selenous acid, hydronitric acid, boric acid, molybdic acid, perxenic acid, silicofluoric acid, telluric acid, tellurous acid, tungstic acid, xenic acid, citric acid, formic acid, pyroantimonic acid, permanganic acid, manganic acid, antimonic acid, antimonous acid, silicic acid, titanic acid, arsenic acid, pertechnetic acid, hydroarsenic acid, dichromic acid, tetraboric acid, metastannic acid, hypooxalous acid, ferricyanic acid, cyanic acid, silicous acid, hydrocyanic acid, thiocyanic acid, uranic acid, and diuranic acid.

Examples of organic acids include malonic acid, citric acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, and sulfonic acids, such as p-toluene sulfonic acid.

Examples of inorganic bases include aluminum hydroxide, ammonium hydroxide, arsenic hydroxide, barium hydroxide, beryllium hydroxide, bismuth(iii) hydroxide, boron hydroxide, cadmium hydroxide, calcium hydroxide, cerium(iii) hydroxide, cesium hydroxide, chromium(ii) hydroxide, chromium(iii) hydroxide, chromium(v) hydroxide, chromium(vi) hydroxide, cobalt(ii) hydroxide, cobalt(iii) hydroxide, copper(i) hydroxide, copper(ii) hydroxide, gallium(ii) hydroxide, gallium(iii) hydroxide, gold(i) hydroxide, gold(iii) hydroxide, indium(i) hydroxide, indium(ii) hydroxide, indium(iii) hydroxide, iridium(iii) hydroxide, iron(ii) hydroxide, iron(iii) hydroxide, lanthanum hydroxide, lead(ii) hydroxide, lead(iv) hydroxide, lithium hydroxide, magnesium hydroxide, manganese(ii) hydroxide, manganese(vii) hydroxide, mercury(i) hydroxide, mercury(ii) hydroxide, molybdenum hydroxide, neodymium hydroxide, nickel oxo-hydroxide, nickel(ii) hydroxide, nickel(iii) hydroxide, niobium hydroxide, osmium(iv) hydroxide, palladium(ii) hydroxide, palladium(iv) hydroxide, platinum(ii) hydroxide, platinum(iv) hydroxide, plutonium(iv) hydroxide, potassium hydroxide, radium hydroxide, rubidium hydroxide, ruthenium(iii) hydroxide, scandium hydroxide, silicon hydroxide, silver hydroxide, sodium hydroxide, strontium hydroxide, tantalum(v) hydroxide, technetium(ii) hydroxide, tetramethylammonium hydroxide, thallium(i) hydroxide, thallium(iii) hydroxide, thorium hydroxide, tin(ii) hydroxide, tin(iv) hydroxide, titanium(ii) hydroxide, titanium(iii) hydroxide, titanium(iv) hydroxide, tungsten(ii) hydroxide, uranyl hydroxide, vanadium(ii) hydroxide, vanadium(iii) hydroxide, vanadium(v) hydroxide, ytterbium hydroxide, yttrium hydroxide, zinc hydroxide, and zirconium hydroxide.

Organic bases typically are nitrogenous, as they can accept protons in aqueous media. Exemplary organic bases include primary, secondary, and tertiary (C₁₋₁₀)-alkylamines, such as methyl amine, trimethylamine, and the like. Additional examples are (C₆₋₁₀)-arylamines and (C₁₋₁₀)-alkyl-(C₆₋₁₀)-aryl-amines. Other organic bases incorporate nitrogen into cyclic structures, such as in mono- and bicyclic heterocyclic and heteroaryl compounds. These include, for instance, pyridine, imidazole, benzimidazole, histidine, and phosphazenes.

In some processes described herein, the inorganic compound is combined with the solvent to obtain a mixture. According to various embodiments, the solvent is present in about 40% or less by weight, based upon the total weight of the mixture. Alternatively, the weight percentage of the solvent in the mixture is 35% or less, 30% or less, 25% or less, 20% or less, 15% or less, 10% or less, 5% or less, 3% or less, or 1% or less.

### Polymers

A great variety of polymers are suitable for use in the cold-sintered ceramic polymer composites and processes described herein. Polymers suitable for use in the present invention are those that are amenable to the temperature and pressures under the reaction conditions of the cold-sintering process described herein, such that the polymer is able to melt, flow, and/or soften to a degree that allows the polymer to fill inter- and intraparticle voids in the sintered ceramic structure within the cold-sintered ceramic polymer composite. Polymers satisfying these basic criteria can be referred to generally as non-sinterable polymers.

In contrast, other polymers do not appreciably melt, flow, and/or soften under the cold-sintering conditions described herein. Rather, these polymers can be compressed and densified under external pressure, and they maintain or form granular or fibrous microstructures in the sintering process. Therefore these polymers can be referred to generally as sinterable polymers.

In some embodiments, the polymer has a melting point (Tₘ) if the polymer is crystalline or semi-crystalline some polymers, even if crystalline or semi-crystalline, also possess a glass transition temperature (T_{g}). However, in these cases, the Tₘ is the defining characteristic for which the polymer is selected for use in the present invention. Melting points (Tₘ) are measured by methods and instruments that are well known in the polymer arts.

Other polymers, such as amorphous polymers, do not possess a Tₘ, but instead can be characterized by a glass transition temperature T_{g} that is measured by methods and instruments well known in the polymer arts.

In some embodiments, each polymer in the cold-sintered ceramic polymer composite is chosen such that its Tₘ, if the polymer is crystalline or semi-crystalline, or its T_{g}, if the polymer is amorphous, is less than the temperature (T₁) that is 200° C. above the boiling point of the solvent or solvent mixture (as determined at 1 bar) that is used in the cold sintering process described herein. Thus, according to one illustrative embodiment, the solvent is water, which has a boiling point of 100° C. at one bar, and so the polymer should have a Tₘ or T_{g} that is no greater than 300° C. In other embodiments, T₁ is between about 70° C. to about 250° C., or between about 100° C. to about 200° C. Although water can be a solvent in these illustrative embodiments because T₁ is no greater than 200° C. above the boiling point of water at one bar, various other solvents and solvent mixtures satisfy these basic requirements.

Notwithstanding the polymer selection criteria that are set forth above, it should be understood for these various embodiments that the polymer is not polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion).

In other embodiments, however, a suitable polymer is selected primarily on the basis of the polymer being a branched polymer and it can, in some embodiments, additionally be selected according to Tₘ or T_{g} as discussed above. A branched polymer, as is understood in the polymer arts, is a polymer that is not entirely linear, i.e., the backbone of the polymer contains at least one branch, and in some embodiments the degree of branching is substantial. Without wishing to be bound by any particular theory, the inventors believe, according to various embodiments, that branched polymers sheer under the pressures employed during the cold sintering process, enabling a given branched polymer to undergo a higher flow than its linear counterpart, such that only the branched polymer is suitable for making a cold-sintered ceramic polymer composite as described herein.

Examples of polymer architectures contemplated for use in the inventive processes include linear and branched polymers, copolymers such as random copolymers and block copolymers, and cross-linked polymers. Also contemplated are polymer blends, and blends of cross-linked polymers with non-crosslinked polymers.

Exemplary classes of polymers include polyimides, a polyamides, polyesters, polyurethanes, polysulfones, polyketones, polyformals, polycarbonates, and polyethers. Additional classes and specific polymers include acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), polyethylene terephthalate (PET), polyetherimide (PEI), poly(p-phenylene oxide) (PPO), polyamide(PA), polyphenylene sulfide (PPS), polyethylene (PE) (e.g., ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), and combinations thereof.

Additional polymers include polyacetylenes, polypyrroles, polyanilines, poly(p-phenylene vinylene), poly(3-alkylthiophenes), polyacrylonitrile, poly(vinylidene fluoride), polyesters (such as polyalkylene terephthalates), polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes (such as polydimethylsiloxane), polyamides (such as nylons), acrylics, sulfonated polymers, co-polymers thereof, and blends thereof.

Other useful polymers are ionic polymers or oligomers (“ionomers”). A key feature of ionomers resides in a relatively modest concentration of acid or ionic groups that are bound to an oligomer/polymer backbone, and that confer substantial changes in the physical, mechanical, optical, dielectric, and dynamic properties to a polymer and, hence, to the cold-sintered ceramic polymer composite. For example, polymers that bear acid functional groups can undergo interchain and physical crosslinks via hydrogen bonding between acid groups. Illustrative oligomers include sulfonated oligomers. In addition, fatty acids or tetra-alkyl ammonium salts can be introduced by the inventive processes in order to promote additional ionic interactions.

### Additional Components

Various embodiments of the inventive processes contemplate the introduction of one or more additional materials to the mixture for cold sintering, or to the cold-sintered ceramic polymer composite. Any combination of these materials is possible to ease manufacture of and/or tailor the composition and properties of the cold-sintered ceramic polymer composite. In general, any of the additives described herein are present in an amount of about 0.001 wt % to about 50 wt %, about 0.01 wt % to about 30 wt %, about 1 to about 5 wt %, or about 0.001 wt % or less, or about 0.01 wt %, 0.1, 1, 2, 3, 4, 5, 10, 15, 20, 25, 30, 35, 40, 45 wt %, or about 50 wt % or more, based upon the total weight of the cold-sintered ceramic polymer composite.

### Supramolecular Structures

For instance, some embodiments provide for the addition of supramolecular structures, which are generally characterized by an assembly of substructures that are held together by weak interactions, such as non-covalent bonds can be used. The interactions can weaken at temperatures that are employed for cold-sintering, thereby liberating substructure molecules that can flow through or into newly-created pores of the particulate inorganic compound or cold-sintered ceramic. Upon cooling, the substructure molecules can reassemble into supramolecular structures that are embedded into the cold-sintered ceramic. Typical compounds suitable for this purpose are hydrogen bonded molecules, which can possess, for instance mono, bi, tri-, or quadruple hydrogen bonds. Other structures exploit host-guest interactions and in this way create supramolecular (polymeric) structures.

Examples of supramolecular structures include macrocycles such as cyclodextrins, calixarenes, cucurbiturils, and crown ethers (host-guest interaction based on weak interactions); amide or carboxylic acid dimers, trimer or tetramers such as 2-ureido-4[1H]-pyrimidinones (via hydrogen bonding), bipyridines or tripyridines (via complexation with metals), and various aromatic molecules (via pi-pi interaction).

### Sol-Gels

Other embodiments provide for the introduction of sol-gels into the mixture of cold-sintered ceramic. The sol-gel process consists of a series of hydrolysis and condensation reactions of a metal alkoxide, and in some instances alkoxysilanes are also used. Hydrolysis is initiated by the addition of water to the alkoxide or silane solution under acidic, neutral, or basic conditions. Thus, by adding a small amount of water to a metal alkoxide, a polymeric nanocomposite can be obtained. Examples of compounds that are useful for making sol-gels include silicon alkoxides such as tetraalkyl orthosilicates (e.g., tetraethyl orthosilicate), silsesquioxanes, and phenyltriethoxysilanes.

### Fillers

According to some embodiments, the cold-sintered ceramic polymer composite can include one or more fillers. The filler is present in about 0.001 wt % to about 50 wt % of the composite, or about 0.01 wt % to about 30 wt %, or about 0.001 wt % or less, or about 0.01 wt %, 0.1, 1, 2, 3, 4, 5, 10, 15, 20, 25, 30, 35, 40, 45 wt %, or about 50 wt % or more. The filler can be homogeneously distributed in the composite. The filler can be fibrous or particulate. The filler can be aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can be talc, kenaf fiber, or combinations thereof. The filler can be coated with a layer of metallic material to facilitate conductivity, or surface treated with silanes, siloxanes, or a combination of silanes and siloxanes to improve adhesion and dispersion within the composite. The filler can be selected from carbon fibers, mineral fillers, and combinations thereof. The filler can be selected from mica, talc, clay, wollastonite, zinc sulfide, zinc oxide, carbon fibers, glass fibers, ceramic-coated graphite, titanium dioxide, or combinations thereof.

### Metals and Carbon

In various embodiments, the cold-sintered ceramic polymer composite includes one or more elemental metals. The metal is present in a powderized or particulate form, such as nanoparticles wherein the number average particle size ranges from about 10 nm to about 500 nm. Exemplary metals include but are not limited to lithium, beryllium, sodium, magnesium, aluminum, potassium, calcium, scandium, titanium, vanadium, chromium, manganese, iron, cobalt, nickel, copper, zinc, gallium, rubidium, strontium, yttrium, zirconium, niobium, molybdenum, technetium, ruthenium, rhodium, palladium, silver, cadmium, indium, tin, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, bismuth, polonium, francium, radium, actinium, thorium, protactinium, uranium, neptunium, plutonium, americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, ununtrium, fierovium, ununpentium, livermorium, and combinations thereof.

In other embodiments, optionally in combination with any other embodiment, the cold-sintered ceramic polymer composite include one or more forms of carbon. Carbon can be introduced into the mixture of polymer and inorganic compound(s) prior to the cold sintering step of the processes described herein. Various forms of carbon are suitable for use in the invention, including graphite, nanotubes, graphene, carbon black, fullerenes, amorphous carbon, pitch, and tar.

### Additional Process Steps

The final physical form and properties of the cold-sintered ceramic polymer composite can be tailored by performing additional steps that occur before and/or after the cold-sintering step. For example, the inventive process in various embodiments includes one or more steps that include injection molding, autoclaving, calendering, dry pressing, tape casting, and extrusion. The steps can be performed on the mixture so as to impose physical forms or geometry that is retained after the cold-sintering step. In this manner, for instance, the step of calendering can ultimately yield sheet-like forms of the cold-sintered ceramic polymer composite. Alternatively, mechanical parts with complex geometries, features, and shapes can be produced by first injection molding the mixture, which is then cold sintered.

Alternatively, or in addition, a variety of post-curing or finishing steps are introduced. These include, for instance, annealing and machining. An annealing step is introduced, in some embodiments, where greater physical strength or resistance to cracking is desired in the cold-sintered ceramic polymer composite. In addition, for some polymers or polymer combinations, the cold-sintering step, while sufficient to sinter the ceramic, does not provide enough heat to ensure complete flow of the polymer(s) into the ceramic voids. Hence, an annealing step can provide the heat for a time sufficient for complete flow to be achieved, and thereby ensure improved break-down strength, toughness, and tribological properties, for instance, in comparison to a cold-sintered ceramic polymer composite that did not undergo an annealing step.

Alternatively, the cold-sintered ceramic polymer composite can be subjected to optionally pre-programmed temperature and/or pressure ramps, holds, or cycles, wherein the temperature or pressure or both are increased or decreased, optionally multiple times.

The cold-sintered ceramic polymer composite also can be machined using conventional techniques known in the art. A machining step can be performed to yield finished parts. For instance, a pre-sintering step of injection molding can yield an overall shape of a part, whilst a post-sintering step of machining can add detail and precise features.

### EXAMPLES

The following examples further illustrate additional embodiments of the invention. Hence, the examples are not intended to limit the scope of the invention.

### Example 1A: Cold-Sintered Ceramic Polymer Composite

Cold-sintered Ceramic Polymer Composites are made using different types of ceramics and polymers. Powders of inorganic compound starting materials and polymers along with small amount of liquid are mixed using a mortar and pestle. The resulting mixture is then put in a cylindrical mold and hot pressed. The pressing is performed at various temperatures, holding times and pressures. The densification of the Cold-sintered Ceramic Polymer Composite is analyzed by measuring the bulk density (e.g. Archimedes method) and by observing the microstructure using SEM/TEM.

### Example 2A: Cold-Sintered Ceramic Polymer Metal Composite

Cold-sintered Ceramic Polymer Metal Composites are made using different types of inorganic compound starting materials, metals and polymers. Powders of inorganic compound(s), polymer, and metal along with small amount of liquid are mixed using a mortar and pestle. The resulting mixture is then put in a cylindrical mold and hot pressed. The pressing is performed at various temperatures, holding times and pressures. The densification of ceramic-polymer-metal composite is analyzed by measuring the bulk density and by observing the microstructure using SEM/TEM

### Example 3A: Cold-Sintered Ceramic Polymer Composite with Electronic Conductivity

Ceramics are traditionally known for their electrical insulation property. The addition of conductive fillers within the sintered ceramic body can allow it to increase electrical conductivity. Examples of different conductive fillers include conductive polymers that are incorporated within the ceramic matrix to improve its electrical conductivity. Conductive polymers (also known as intrinsically conducting polymers (ICPs)) are a group of polymers that can conduct electricity. Conductive polymers consist of linear-backbone such as polyacetylene, polypyrrole, and polyaniline, and their copolymers. Poly (p-phenylene vinylene) (PPV) and its soluble derivatives are useful as electroluminescent semiconducting polymers. Poly(3-alkylthiophenes) are archetypical materials for solar cells and transistors.

Metals and graphites are well known conductors of electricity. Incorporation of these materials show improvement in electrical conductivity.

Cold-sintered Ceramic Polymer Composites with improved electrical conductivity are useful in organic solar cells, printing electronic circuits, organic light-emitting diodes, actuators, electrochromism, supercapacitors, batteries, chemical sensors and biosensors, flexible transparent displays, and electromagnetic shielding.

### Example 4A: Cold-Sintered Ceramic Polymer Composite with Ionic Conductivity

Cold-sintered Ceramic Polymer Composites are made with improved ionic conductivity. Incorporation of ionically conductive polymers such as polyacrylonitrile (PAN), poly(ethylene oxide), poly(vinylidene fluoride), poly(methyl methacrylate) yield improved ionic conductivity. Also, the incorporation of fast ionic conductors (FICs) such as polyacrylamides, agar, Nafion, yttria-stabilized zirconia, beta alumina, fluoride ion conductors, iodides, silver sulfide, lead chloride, strontium titanate, strontium stannate, Zr(HPO₄)₂.nH₂O and UO₂HPO₄.nH₂O enhance the ionic conductivity. One possible application of CCM is in solid state batteries and supercapacitors.

### Example 5A: Cold-Sintered Ceramic Polymer Composite with Toughness

Due to the absence of mobile dislocation activity, most ceramics, such as Al₂O₃, ZrO₂, SiC, and Si₃N₄, suffer from the lack of plastic deformation and, hence, they are inherently brittle with an extreme sensitivity to flaws. The toughening of ceramics is typically achieved extrinsically, i.e., through the use of microstructures that can promote crack-tip shielding mechanisms such as crack deflection, in-situ phase transformations, constrained micro-cracking, and crack bridging.

Unlike ceramics, polymers do not contain crystallographic planes, dislocations, and grain boundaries but rather consist of covalently bonded molecular network. The deformation of polymers is plastic in nature. The incorporation of polymers within the sintered ceramic body helps to improve the toughness of the Cold-sintered Ceramic Polymer Composite. The incorporation of reinforcing additives in the form of powder (1 nm to 500 μm), fibers or whiskers within the ceramic matrix can inhibit crack propagation thereby prevent the Cold-sintered Ceramic Polymer Composite material from brittle failures.

### Example 6A: Phase Changed Materials (PCMs) Incorporated into Cold-Sintered Ceramic Polymer Composite

Thermal energy storage can improve the performance and reliability of energy systems. The use of PCMs for latent heat thermal energy storage (LHTES) is a preferred method because of their safety, stability and high energy storage density. A large number of organic and inorganic substances and eutectics have been explored as PCMs. PCMs are therefore incorporated within the ceramic body using the cold sintering process described herein.

### Example 7A: Cold-Sintered Ceramic Polymer Composite with Tribological Properties

The incorporation of non-ceramic materials in a Cold-sintered Ceramic Polymer Composite can reduce the co-efficient of friction. For instance, a Cold-sintered Ceramic Polymer Composite is prepared from polystyrene and alumina powder and a mix of steel and alumina powders. The friction and wear behavior of of the composite is determined in dry sliding conditions. Tests are conducted at different normal loads and sliding velocities at room temperature. Coefficients of friction and wear loss during the wear tests are determined. Ceramic materials such as sulfides including copper sulfide and molybdenum sulfide either as matrix material or additive can improve the tribological properties.

### Example 8A: Cold-Sintered Ceramic Polymer Composite with Processability

Polymers are easy to process in comparison to ceramics. Various Cold-sintered Ceramic Polymer Composites are prepared and compared to corresponding ceramics lacking the polymer components. The incorporation of polymer improves the processability of the Cold-sintered Ceramic Polymer Composites as demonstrated through different processing conditions.

### Example 9A: Cold-Sintered Ceramic Polymer Composites with Non-Sinterable Polymers

Bulk densities are determined for various Cold-sintered Ceramic Polymer Composites made using non-sinterable polymers. Non-sinterable polymers is a group of polymers that does not get sintered when the ceramic and polymer mixture is subjected to pressure and temperature of CSP. Non-sinterable polymers are typically polymers which have amorphous structure or low amount of crystallinity in their structure.

### Example 10A: Cold-Sintered Ceramic Polymer Composites with Breakdown Strength

Cold-sintered Ceramic Polymer Composites are alternatives to polymeric and ceramic dielectrics used for high voltage capacitors, high temperature insulation and transistors. The combination of increased dielectric strength, increased dielectric permittivity, gradual failure modes, material tunability and processability, provide an attractive properties over just polymer or just ceramic materials. Polymers are commonly employed due to their processability and high breakdown strength; however, demands for higher energy storage have been growing. The incorporation of polymer within a ceramic body of Cold-sintered Ceramic Polymer Composites result in increased breakdown strength.

### Example 11A: Cold-Sintered Ceramic Polymer Composites with Dielectric Constant

Ceramics, especially ferroelectric ceramics, have a high dielectric constant but are brittle and have a low dielectric strength, whereas polymers are flexible and easy to process and have a high dielectric strength but have a very small dielectric constant. Cold-sintered Ceramic Polymer Composites combines the advantages of ceramics and polymers, and they are materials that are flexible and easy to process, and are of relatively high dielectric constant and high breakdown strength.

### Example 12A: Cold-Sintered Ceramic Polymer Composites with High Continuous-Use Temperature

The selection of polymer that is used in Cold-sintered Ceramic Polymer Composites can affect the composites' high continuous-use temperature.

### Example 13A: Cold-Sintered Ceramic Polymer Composites with Sinterable Polymers

Sinterable polymers are polymers that undergo sintering. They are typically polymers with high melting point and are not processable by conventional melt processing techniques. In general, polymers having a melting point of at least 200° C. are suitable as a sinterable polymers. Examples of such polymers are polytetrafluorcethylene (PTFE), tetrafluoroethylene (ETFE), polytrifluorochloroethylene (PCTFE), trifluorochloroethylene (ECTFE), perfluoroalkoxy (PFA), polyaryl ether ketone (PEK), polyarylene sulfone (PSU), polyaryl ether sulfones (PES), polyarylene sulfide (PAS), polyimide (PI), polyamidoimides (PAI), polyetherimides (PEI), polyesterimides, polyhydantoins, polycycloenes, liquid crystalline polymers (LCP), polyarylensulfide, polyoxadiazobenimidazole, polybenzimidazole (PBI) and polyimidazopyrolone (pyrone). In comparison to non-sinterable polymers, the incorporation of sinterable polymers provides higher bulk density. Further, because sinterable polymers have higher melting temperatures, they can also be processed and used at high temperatures.

### Example 15A: Cold-Sintered Ceramic Polymer Composites with Triboelectric Materials

A triboelectric material is a type of material is electrically charged when it comes into frictional contact with a different material. In general, ceramics exhibits weak triboelectric properties, whereas polymers exhibits good triboelectric properties. The Cold-sintered Ceramic Polymer Composites can improve the triboelectric properties. Some examples of polymers that exhibit triboelectric properties are polydimethysiloxane (PDMS), nylon, acrylic, etc. Depending on the type of polymer, the Cold-sintered Ceramic Polymer Composites exhibits positive or negative triboelectric behavior. Triboelectric property is enhanced when positive and negative triboelectric materials are used against each other. Triboelectric materials can be used to harvest energy.

### Example 16A: Cold-Sintered Ceramic Polymer Composites with Compatibilizers

Compatibilization is the addition of a material to an immiscible blend of polymers to improve their stability and processing. Cold-sintered Ceramic Polymer Composites are prepared by incorporating various compatibilizers. Illustrative compatibilizers are functionalized polymers such as acid functional olefins, DuPont's Fusabond®, DuPont's Elvaloy®, etc.

General Materials and Procedures

The following information applies to the Experimental Examples and Comparative Examples below.

Sodium dimolybdate (Na₂Mo₂O₇; NMO) was fabricated using a solid state reaction as follows: Na₂CO₃ (99.95%, Alfa Aesar) and MoO₃ (99.5%, Alfa Aesar) were mixed in the necessary ratios via ball milling in ethanol for 24 hours to give a mixture. The mixture was dried at 85° C. and then heated in a box furnace to 500° C. for 5 hours to yield NMO. The resulting NMO powder was milled via ball milling in ethanol for 24 hours and then dried again at 85° C. The X-ray diffraction (XRD) pattern of all NMO batches prepared by this procedure show phase pure samples.

Lithium Molybdate (LMO) was acquired from Sigma-Aldrich. The particle size (in micrometer) was measured with Malvern Masterziser 2000. LMO as received exhibited a particle size of d10=60, d50=191, d90=620. Milled LMO exhibited a particle size of d10=7, d50=28, d90=83. Theoretical density=3.03 g/cc

Zinc Oxide was acquired from Sigma Aldrich. The BET surface has an average particle size of 200 nm. Theoretical density=5.61 g/cc

Polymer powders of polycarbonate (PC), polyetherimide (PEI), and polyethylene (PE) were obtained either internally or commercially from Michelman (Michem Emulsions) (PP, PE). The emulsions were reported to have polymer particle sizes of ˜1 um. Drying of the aqueous emulsions was performed at 80° C. in a vacuum oven to prevent viscous sintering during drying. The dried emulsions were ground using a mortar and pestle.

Water=De-ionized water. Die=Stainless steel with 13 mm diameter cavity. Press=desktop hydraulic press (Dake, Model B-10). Heater=a heater band (Grangier, Item #2VYA3, Mfr. Model# NHW00142) and control thermocouple (Watlow-distributor.com; 72XTSGB036D) using a power supply (J-Kem Scientific, Model 210). Relative density (%)=(measured density/theoretical density)*100.

### Comparative Example 1: Pure LMO Cold Sintered Ceramic

An amount of 1.5 gram LMO was added to a mortar and ground with a pestle to an average particle size of about 99 micron. To this powder deionized water was added and mixed for about 2 minutes to form a paste like substance. The substance was added to the stainless steel die and pressed into a ceramic pellet with high density. Experiments were conducted with varying pressure and temperature and the effects on relative density are charted in Table 1A and Table 1B. Effects of solvent content on relative density are presented in Table 1C.

TABLE 1A
The effect of temperature and pressure on the relative density.

| | | Solvent | |
|---|---|---|---|
| Temperature | Pressure | content | Relative |
| (° C.) | (MPa) | (vol %) | Density (%) |
| 30 | 275.8 | 13 | 92.1 |
| 70 | 275.8 | 13 | 94.5 |
| 120 | 275.8 | 13 | 96.4 |
| 160 | 275.8 | 13 | 97.9 |
| 200 | 275.8 | 13 | 99.1 |

TABLE 1B
The effect of pressure on the relative density.

| | | Solvent | |
|---|---|---|---|
| Temperature | Pressure | content | Relative |
| (° C.) | (MPa) | (μL/g) | Density (%) |
| 120 | 69.0 | 130 | 77.2 |
| 120 | 103.4 | 130 | 84.0 |
| 120 | 137.9 | 130 | 91.0 |
| 120 | 206.9 | 130 | 95.9 |
| 120 | 275.8 | 130 | 96.4 |

TABLE 3
The effect of solvent content on the relative density.

| | | Solvent | |
|---|---|---|---|
| Temperature | Pressure | content | Relative |
| (° C.) | (MPa) | (μL/g) | Density (%) |
| 120 | 275.8 | 0 | 86.5 |
| 120 | 275.8 | 20 | 96.5 |
| 120 | 275.8 | 40 | 96.9 |
| 120 | 275.8 | 70 | 96.3 |
| 120 | 275.8 | 130 | 96.4 |

### Comparative Example 2: Pure Milled-LMO Cold Sintered Ceramic

An amount of 1.5 gram milled LMO was added to a mortar and ground with a pestle to an average particle size of about 99 micron. To this powder deionized water was added and mixed for about 2 minutes to form a paste like substance. The substance is added to the stainless steel die and pressed into a ceramic pellet with high density. Experiments were conducted with varying pressure and the effects on relative density are plotted in Table 2.

TABLE 2
Relative Density of sintered milled-LMO ceramic pellets

| | | Relative |
|---|---|---|
| Temperature | Pressure | Density |
| (° C.) | (MPa) | (%) |
| 120 | 69.0 | 96.9 |
| 120 | 103.4 | 97.2 |

### Comparative Example 3: Pure NMO Cold Sintered Ceramic

An amount of 1.5 gram NMO was added to a mortar and ground with a pestle to an average particle size of about 99 micron. To this powder deionized water was added and mixed for about 2 minutes to form a paste like substance. The substance is added to the stainless steel die and pressed into a ceramic pellet with high density. Experiments were conducted with varying pressures, temperatures, and solvent contents, and their effects on relative density are plotted in Tables 3A-3C.

TABLE 3A
The effect of temperature on the relative density.

| | | Solvent | Relative |
|---|---|---|---|
| Temperature | Pressure | content | Density |
| (° C.) | (MPa) | (ul/g) | (%) |
| 30 | 275.8 | 130 | 84.1 |
| 50 | 275.8 | 130 | 86.5 |
| 70 | 275.8 | 130 | 93 |
| 100 | 275.8 | 130 | 93.7 |
| 120 | 275.8 | 130 | 96.3 |

TABLE 3B
The effect of pressure on the relative density.

| | | Solvent | Relative |
|---|---|---|---|
| Temperature | Pressure | content | Density |
| (° C.) | (MPa) | (ul/g) | (%) |
| 120 | 69.0 | 130 | 94.5 |
| 120 | 103.4 | 130 | 96.5 |
| 120 | 165.5 | 130 | 96.3 |
| 120 | 275.8 | 130 | 95.9 |
| 120 | 331.0 | 130 | 95.5 |

TABLE 3C
The effect of solvent content on the relative density.

| | | Solvent | Relative |
|---|---|---|---|
| Temperature | Pressure | content | Density |
| (° C.) | (MPa) | (ul/g) | (%) |
| 120 | 275.8 | 0 | 74.5 |
| 120 | 275.8 | 20 | 97.5 |
| 120 | 275.8 | 35 | 98 |
| 120 | 275.8 | 70 | 98.9 |
| 120 | 275.8 | 130 | 93.7 |

### Experimental Example 1: NMO/PEI Via Cold-Sintering

1 g of 10 vol % PEI (ULTEM™ 1000; Dv50 particle size 15 μm) filled NMO powder was added to a mortar, wherein a 50 or 100 μL/g de-ionized water was added. The resultant mixture was then ground to a paste-like consistency using a pestle. The substance is added to the stainless steel die and pressed into a ceramic pellet with high density. Experiments were conducted with either 134.0 MPa or 268.0 MPa for 30 min. The effect of relative density on temperature is presented in Table 4.

TABLE 4
The effect of temperature, pressure and
solvent content on the relative density.

| Temperature | Pressure | solvent | Relative |
|---|---|---|---|
| (° C.) | (MPa) | (μl/g) | Density (%) |
| 120 | 134.0 | 50 | 98.1 |
| 120 | 134.0 | 50 | 96.9 |
| 180 | 134.0 | 50 | 98.1 |
| 180 | 134.0 | 50 | 97.6 |
| 180 | 134.0 | 50 | 97.4 |
| 240 | 134.0 | 50 | 94.3 |
| 240 | 134.0 | 50 | 95.6 |
| 240 | 134.0 | 50 | 97 |
| 120 | 268.0 | 100 | 96.7 |
| 120 | 268.0 | 100 | 95.5 |
| 120 | 268.0 | 100 | 95.2 |
| 150 | 268.0 | 100 | 97.9 |
| 180 | 268.0 | 100 | 94.4 |
| 180 | 268.0 | 100 | 90.8 |
| 210 | 268.0 | 100 | 95 |
| 240 | 268.0 | 100 | 93.3 |
| 240 | 268.0 | 100 | 93 |
| 240 | 268.0 | 100 | 89.3 |
| 240 | 268.0 | 100 | 86.7 |

### Experimental Example 2: NMO/Polyethylene Composites Via Cold-Sintering

A series of NMO powder samples (1 g) containing varying amounts of PE were individually added to a mortar, wherein 50 or 100 μl/g de-ionized water was added. The resultant mixture was then ground to a paste-like consistency using a pestle. The substance was added to the stainless steel die and pressed into a ceramic pellet with high density. Experiments were conducted with either 268.0 MPa or 134.0 MPa at 120° C. for 30 min. The effect of relative density on PE vol % is presented in Table 5.

TABLE 5
The effect of PE vol % on the relative density

| | | | solvent | Relative |
|---|---|---|---|---|
| NMO | PE | Pressure | content | Density |
| vol % | vol % | (MPa) | (μl/g) | (%) |
| 100 | 0 | 268.0 | 100 | 96.4 |
| 100 | 0 | 268.0 | 100 | 94.2 |
| 90 | 10 | 268.0 | 100 | 96 |
| 90 | 10 | 268.0 | 100 | 94.5 |
| 90 | 10 | 268.0 | 100 | 94 |
| 90 | 10 | 268.0 | 100 | 92.7 |
| 90 | 10 | 268.0 | 100 | 91.4 |
| 90 | 10 | 268.0 | 100 | 89 |
| 70 | 30 | 268.0 | 100 | 92 |
| 70 | 30 | 268.0 | 100 | 87.2 |
| 70 | 30 | 268.0 | 100 | 84 |
| 50 | 50 | 268.0 | 100 | 91.4 |
| 50 | 50 | 268.0 | 100 | 91.2 |
| 50 | 50 | 268.0 | 100 | 89.7 |
| 30 | 70 | 268.0 | 100 | 94.2 |
| 0 | 100 | 268.0 | 100 | 95.6 |
| 50 | 50 | 134.0 | 50 | 95.4 |

### Experimental Example 3: LMO/Polyetherimide Composites Via Cold-Sintering

1 g of PEI (ULTEM™ 1000; Dv50 particle size 15 um) filled LMO powder was added to a mortar, wherein a 50 μL/g de-ionized water was added. The resultant mixture was then ground to a paste-like consistency using a pestle. The substance is added to the stainless steel die and pressed into a ceramic pellet with high density. Experiments were conducted with 134.0 MPa² at 120° C. or 240° C. for 30 min. The effect of relative density on PE vol % is plotted in Tables 6 and 7. It was noted that LMO/PEI composites sintered at 240° C. exhibited a lower relative density than those sintered at 120° C. This was solved by applying during the cooling phase of the experiment that resulted in more than 96% relative density.

TABLE 6
The effect of PEI vol % on the relative density at 120° C.

| LMO | PEI | Relative |
|---|---|---|
| vol % | vol % | Density (%) |
| 100 | 0 | 97.4 |
| 80 | 20 | 98.2 |
| 80 | 20 | 97.9 |
| 80 | 20 | 98.5 |
| 60 | 40 | 98.0 |
| 60 | 40 | 98.3 |
| 60 | 40 | 96.7 |
| 40 | 60 | 97.4 |
| 40 | 60 | 97.7 |
| 40 | 60 | 97.1 |
| 20 | 80 | 98.0 |
| 20 | 80 | 98.2 |
| 20 | 80 | 97.9 |

TABLE 7
The effect of cooling condition and solvent
content on the relative density at 240° C.

| | | Pressure | solvent | |
|---|---|---|---|---|
| LMO | PEI | on while | content | Relative |
| vol % | vol % | cooling | (μl/g) | Density (%) |
| 90 | 10 | No | 50 | 87.5 |
| 90 | 10 | Yes | 50 | 96.9 |
| 90 | 10 | No | 25 | 87.1 |
| 90 | 10 | No | 12.5 | 79.9 |
| 60 | 40 | No | 50 | 64.8 |
| 60 | 40 | Yes | 50 | 97.5 |
| 80 | 20 | No | 50 | 73.3 |
| 80 | 20 | No | 25 | 79 |
| 80 | 20 | No | 12.5 | 86 |

### Experimental Example 4: LMO/Polycarbonate Composites Via Cold-Sintering

A series of LMO powder samples (1 g) containing varying amounts of PC filled were individually added to a mortar, wherein 50 μl/g de-ionized water was added. The resultant mixture was then ground to a paste-like consistency using a pestle. The substance is added to the stainless steel die and pressed into a ceramic pellet with high density. Experiments were conducted with 134.0 MPa at 120° C. for 30 min. The effect of relative density on PC Dv50 particle size and vol % is plotted in Table 8.

TABLE 8
The effects of PC vol % and Dv50 particle
size on the relative density.

| | | PC DV50 | |
|---|---|---|---|
| LMO | PC | particle size | Relative |
| vol % | vol % | (μm) | Density (%) |
| 100 | 0 | 75-125 | 98.8 |
| 100 | 0 | 75-125 | 98.5 |
| 100 | 0 | 75-125 | 97.7 |
| 100 | 0 | 75-125 | 96.4 |
| 80 | 20 | 75-125 | 97.8 |
| 80 | 20 | 75-125 | 97.7 |
| 80 | 20 | 75-125 | 97.5 |
| 60 | 40 | 75-125 | 96.8 |
| 60 | 40 | 75-125 | 94.0 |
| 60 | 40 | 75-125 | 94.3 |
| 60 | 40 | 75-125 | 94.5 |
| 40 | 60 | 75-125 | 92.0 |
| 40 | 60 | 75-125 | 92.2 |
| 40 | 60 | 75-125 | 92.5 |
| 20 | 80 | 75-125 | 91.7 |
| 20 | 80 | 75-125 | 90.2 |
| 20 | 80 | 75-125 | 89.5 |
| 0 | 100 | 75-125 | 96.2 |
| 0 | 100 | 75-125 | 94.9 |
| 0 | 100 | 75-125 | 95.3 |
| 40 | 60 | <45 | 94.5 |
| 20 | 80 | <45 | 91.0 |

### Experimental Example 5: Zinc Oxide (ZnO)/Polyetherimide Composites Via Cold-Sintering

1 g of polyetherimide (ULTEM™ 1000; Dv50 particle size 1 um) filled ZnO powder was added to a mortar, wherein a 100 μL/g 1.8M acetic acid solution in de-ionized water was added. The resultant mixture was then ground to a paste-like consistency using a pestle. The substance is added to the stainless steel die and pressed into a pellet. Experiments were conducted with 134.0 MPa at 120° C. for 30 min. The effect of relative density on polyetherimide vol % is plotted in Table 9.

TABLE 9
The effect of polyetherimide vol % on the relative density.

| | | Relative |
|---|---|---|
| ZnO | polyetherimide | Density |
| vol % | vol % | (%) |
| 80 | 20 | 95.3 |
| 60 | 40 | 95.5 |
| 40 | 60 | 92.0 |
| 20 | 80 | 94.7 |

### Experimental Example 6: Post-Anneal

2 g of PEI (ULTEM™ 1010; average particle size Dv50=1 μm) filled LMO powder was added to a mortar, wherein a 100 μL/g de-ionized water was added. The resultant mixture was then ground to a paste-like consistency using a pestle. The substance is added to the stainless steel die and pressed into a ceramic pellet at 268.0 MPa pressure and 120° C. temperature for 30 min. The sample was broken in liquid nitrogen and one half was annealed in an oven for 1 hr at 260° C. Post-annealing the fractured surface both halves were imaged under a SEM and compared. The resulting images demonstrated a clear change in morphology of the polymer particles form spherical morphology at 120° C. to melt-like morphology at 260° C.

### Experiment Example 7: Thermal Conductivities

1 g of PEI (ULTEM™ 1000; Dv50 particle size 1 μm) filled LMO powder was added to a mortar, wherein a 50 μL/g de-ionized water was added. The resultant mixture was then ground to a paste-like consistency using a pestle. The substance is added to the stainless steel die and pressed into a ceramic pellet with high density. Experiments were conducted with 134.0 MPa at 120° C. for 30 min.

Samples as prepared were subjected to thermal conductivity tests utilizing a Retsch 447 Laser Flash Analysis (LFA) equipment in accordance with standards ASTM E1461, DIN EN 821, DIN 30905, and ISO 22007-4:2008. For each sample, thermal diffusivity (a; mm²/s) was measured by LFA, specific heat (cₚ; J/g/K) was measured by differential scanning calorimetry, and density (ρ; g/cm³) was measured by hot plate, to calculate thermal conductivity (λ; W/m*K) according to the equation:

λ(T)=α(T)·cₚ(T)·ρ(T)

Thermal conductivities were measured according to national and international standards such as ASTM E1461, DIN EN 821, DIN 30905 and ISO 22007-4:2008, and the sample was stabilized at the desired temperature, the laser fired several times over a span of a few minutes and the necessary data is recorded for each laser “shot”. The effect of thermal conductivity on PE vol % is plotted in table 10.

TABLE 10
The effect of PEI vol % on the thermal conductivity.

| LMO | PEI | thermal conductivity |
|---|---|---|
| vol % | vol % | (W/m*K) |
| 100 | 0 | 2.97 |
| 80 | 20 | 1.84 |
| 60 | 40 | 1.02 |
| 40 | 60 | 0.55 |
| 20 | 80 | 0.28 |

### Experimental Example 8: Electrical Properties

0.5 g of PP (Dv50 particle size<1 um) or PEI (ULTEM™ 1000; Dv50 particle size 1 um) filled NMO powder was added to a mortar, wherein a 50 μL/g de-ionized water was added. The resultant mixture was then ground to a paste-like consistency using a pestle. The substance is added to the stainless steel die and pressed into a ceramic pellet with high density. Experiments were conducted with 134.0 MPa at 120° C. for 30 min.

Dielectric Constant and Loss Factor

For dielectric constant and loss measurements, sample thickness was measured using a Heidenhain Metro gauge accurate to ±0.2 μm. Three locations in a 13 mm area were chosen for film thicknesses measurement prior to metallization and their average was used for the dielectric constant calculations. Metalon® HPS-FG32 silver ink was deposited on each sample after drying in a vacuum oven at 120° C. for 2 hours using a 13 mm diameter circular mask. The silver ink coated samples were then cured at 120° C. for 2 hours. An Agilent E4980A Precision LCR Meter synced with a Tenney humidity and temperature chamber was used to measure dielectric constant and dielectric loss as a function of frequency at 23° C., 60° C., 120° C. The connection from the LCR meter was made with a Keysight 16048A test lead kit soldered to two spring probes.

Breakdown Strength

Breakdown strength (BDS) was measured following the ASTM D-149 standard (ramping at 500 V/s). This test utilizes a 6.35 mm stainless steel ball on a brass plate immersed in silicone oil to minimize the electric field non-uniformity and the chances of a film defect being present at the test location. ASTM D-149 returns a value that approaches the entitlement BDS of the sample. The breakdown strength thickness was measured on each sample after polishing with 360 grit sandpaper, rinsing in isopropanol, and drying in a vacuum oven at 120° C. for 2 hours. Thickness was measured using the Heidenhain Metro gauge as described above prior to breakdown. This was done so the ball in-plane measurement could be placed on the exact spot the thickness measurement was taken. Three measurements were made on each sample (with 3 samples made per composition) and the dataset was fit using a 2-parameter Weibull distribution. The scale parameter is the voltage at which 63% of the capacitors have broken down, and β, the shape parameter (also commonly referred to as slope), is the Weibull modulus indicating the width of the distribution. The dielectric oil temperature was kept stable at 23° C.

Results

Tables 11-19 present the dielectric constant at 23° C., 60° C., 120° C. versus frequency ranging from 20 Hz to 1 MHz for bulk NMO and NMO-Polytherimide (PEI) composites. The maximum measurement was dependent on the temperature capability of the polymers Tg or Tm in the polymer-ceramic composite. The tables also present dielectric loss Df (also referred to as dissipation factor or loss tangent) at 23° C., 60° C., and 120° C., as a function of frequency depending on the maximum operating temperature of the polymer in the polymer-ceramic composites.

TABLE 11
Dielectric Constant (DK) and Loss (Df) at 23° C. of Bulk NMO

| Freq | Avg DK | |
|---|---|---|
| (Hz) | (5 samples) | Df |
| 20 | 15.02 | 0.16616 |
| 50 | 14.09 | 0.10943 |
| 100 | 13.65 | 0.08246 |
| 500 | 13.12 | 0.03651 |
| 1000 | 12.98 | 0.02649 |
| 5000 | 12.78 | 0.01406 |
| 10000 | 12.73 | 0.01152 |
| 50000 | 12.61 | 0.00893 |
| 100000 | 11.34 | 0.00949 |
| 500000 | 12.45 | 0.00741 |
| 1000000 | 12.37 | 0.00651 |

TABLE 12
Dielectric Constant (DK) and Loss (Df) at 23° C. of Cold-
sintered NMO with 10% PEI prepared at 120° C.

| Freq | Avg DK | |
|---|---|---|
| (Hz) | (5 samples) | Df |
| 20 | 16.27 | 0.23963 |
| 50 | 16.12 | 0.24763 |
| 100 | 14.90 | 0.17187 |
| 500 | 13.76 | 0.07583 |
| 1000 | 13.48 | 0.05347 |
| 5000 | 13.11 | 0.02475 |
| 10000 | 13.01 | 0.01836 |
| 50000 | 12.87 | 0.00977 |
| 100000 | 11.76 | 0.00343 |
| 500000 | 12.75 | 0.0036 |
| 1000000 | 12.69 | 0.00248 |

TABLE 13
Dielectric Constant (DK) and Loss (Df) at 23° C. of Cold-
sintered NMO with 10% PEI prepared at 240° C.

| Freq | Avg DK | |
|---|---|---|
| (Hz) | (5 samples) | Df |
| 20 | 16.04 | 2.07052 |
| 50 | 16.17 | 1.30437 |
| 100 | 15.51 | 0.73734 |
| 500 | 14.42 | 0.20688 |
| 1000 | 14.09 | 0.12606 |
| 5000 | 13.61 | 0.04517 |
| 10000 | 13.49 | 0.03076 |
| 50000 | 13.29 | 0.01381 |
| 100000 | 11.51 | 0.00582 |
| 500000 | 13.12 | 0.00598 |
| 1000000 | 13.05 | 0.00465 |

TABLE 14
Dielectric Constant (DK) and Loss (Df) at 60° C. of Bulk NMO

| Freq | Avg DK | |
|---|---|---|
| (Hz) | (5 samples) | Df |
| 20 | 19.97 | 0.69128 |
| 50 | 17.35 | 0.41165 |
| 100 | 15.87 | 0.28888 |
| 500 | 14.09 | 0.12148 |
| 1000 | 13.67 | 0.08422 |
| 5000 | 13.12 | 0.03769 |
| 10000 | 12.98 | 0.02771 |
| 50000 | 12.76 | 0.01578 |
| 100000 | 11.46 | 0.01475 |
| 500000 | 12.54 | 0.00942 |
| 1000000 | 12.46 | 0.00784 |

TABLE 15
Dielectric Constant (DK) and Loss (Df) at 60° C. of Cold-
sintered NMO with 10% PEI prepared at 120° C.

| Freq | Avg DK | |
|---|---|---|
| (Hz) | (5 samples) | Df |
| 20 | 88.92 | 1.37721 |
| 50 | 52.69 | 1.3127 |
| 100 | 35.80 | 1.22999 |
| 500 | 19.25 | 0.71587 |
| 1000 | 16.83 | 0.48389 |
| 5000 | 14.48 | 0.17222 |
| 10000 | 14.03 | 0.11092 |
| 50000 | 13.44 | 0.04306 |
| 100000 | 11.29 | 0.03485 |
| 500000 | 13.08 | 0.01303 |
| 1000000 | 12.99 | 0.009 |

TABLE 16
Dielectric Constant (DK) and Loss (Df)
at 60° C. of Cold-sintered NMO with
10% PEI prepared at 240° C.

| Freq | Avg DK | |
|---|---|---|
| (Hz) | (5 samples) | Df |
| 20 | 22.42 | 2.40793 |
| 50 | 19.14 | 1.01908 |
| 100 | 17.77 | 0.55996 |
| 500 | 15.50 | 0.2258 |
| 1000 | 14.89 | 0.15733 |
| 5000 | 14.00 | 0.07341 |
| 10000 | 13.77 | 0.05318 |
| 50000 | 13.46 | 0.02451 |
| 100000 | 11.66 | 0.01362 |
| 500000 | 13.24 | 0.00861 |
| 1000000 | 13.17 | 0.00631 |

TABLE 17
Dielectric Constant (DK) and Loss (Df)
at 120° C. of Bulk NMO

| Freq | Avg DK | |
|---|---|---|
| (Hz) | (5 samples) | Df |
| 20 | 41.27 | 2.04517 |
| 50 | 27.87 | 1.47254 |
| 100 | 22.34 | 1.06505 |
| 500 | 16.63 | 0.42039 |
| 1000 | 15.47 | 0.27853 |
| 5000 | 13.96 | 0.10959 |
| 10000 | 13.61 | 0.07459 |
| 50000 | 13.14 | 0.03355 |
| 100000 | 11.79 | 0.02801 |
| 500000 | 12.78 | 0.0144 |
| 1000000 | 12.68 | 0.0112 |

TABLE 18
Dielectric Constant (DK) and Loss (Df) at 120° C. of Cold-
sintered NMO with 10% PEI prepared at 120° C.

| Freq | Avg DK | |
|---|---|---|
| (Hz) | (5 samples) | Df |
| 20 | 81.41 | 1.43875 |
| 50 | 48.12 | 1.33465 |
| 100 | 34.81 | 1.15679 |
| 500 | 20.65 | 0.64009 |
| 1000 | 18.03 | 0.45815 |
| 5000 | 15.02 | 0.19171 |
| 10000 | 14.38 | 0.13005 |
| 50000 | 13.59 | 0.05275 |
| 100000 | 12.35 | 0.03442 |
| 500000 | 13.15 | 0.01546 |
| 1000000 | 13.06 | 0.01057 |

TABLE 19
Dielectric Constant (DK) and Loss (Df) at 120° C. of Cold-
sintered NMO with 10% PEI prepared at 240° C.

| Freq | Avg DK | |
|---|---|---|
| (Hz) | (5 samples) | Df |
| 20 | 25.67 | 1.49516 |
| 50 | 22.13 | 0.85791 |
| 100 | 20.20 | 0.57785 |
| 500 | 17.06 | 0.26061 |
| 1000 | 16.11 | 0.19969 |
| 5000 | 14.60 | 0.11424 |
| 10000 | 14.20 | 0.08818 |
| 50000 | 13.67 | 0.04421 |
| 100000 | 11.83 | 0.02877 |
| 500000 | 13.36 | 0.01451 |
| 1000000 | 13.28 | 0.01017 |

Tables 20-34 present the dielectric constant and loss at 23° C., 60° C., 120° C. versus frequency ranging from 20 Hz to 1 MHz for bulk NMO and NMO-Polypropylene (PP) composites. The maximum measurement was dependent on the temperature capability of the polymers Tg or Tm in the polymer-ceramic composite.

TABLE 20
Dielectric Constant (DK) and Loss (Df) at
23° C. of Cold-sintered NMO with 10% PP

| Frequency | | |
|---|---|---|
| [Hz] | DK | Df |
| 20 | 13.06 | 0.14613 |
| 50 | 12.80 | 0.06385 |
| 100 | 13.03 | 0.02982 |
| 500 | 12.75 | 0.01433 |
| 1000 | 12.70 | 0.00987 |
| 5000 | 12.64 | 0.0045 |
| 10000 | 12.62 | 0.00355 |
| 50000 | 12.59 | 0.003 |
| 100000 | 11.67 | 0.00203 |
| 500000 | 12.52 | 0.00263 |
| 1000000 | 12.47 | 0.0021 |

TABLE 21
Dielectric Constant (DK) and Loss (Df) at
23° C. of Cold-sintered NMO with 20% PP

| Frequency | | |
|---|---|---|
| [Hz] | DK | Df |
| 20 | 146.21 | 0.03741 |
| 50 | 11.22 | 0.05604 |
| 100 | 9.95 | 0.05002 |
| 500 | 10.44 | 0.03495 |
| 1000 | 10.28 | 0.02718 |
| 5000 | 10.24 | 0.02542 |
| 10000 | 10.11 | 0.00966 |
| 50000 | 10.07 | 0.00359 |
| 100000 | 9.42 | 0.00234 |
| 500000 | 10.02 | 0.00243 |
| 1000000 | 9.98 | 0.00195 |

TABLE 22
Dielectric Constant (DK) and Loss (Df) at
23° C. of Cold-sintered NMO with 30% PP

| Freq | Avg DK | Avg Df |
|---|---|---|
| (Hz) | (5 samples) | (5 samples) |
| 20 | 10.06 | 0.9129070 |
| 50 | 9.53 | 0.4640930 |
| 100 | 9.48 | 0.2806735 |
| 500 | 8.79 | 0.0964576 |
| 1000 | 8.61 | 0.0630528 |
| 5000 | 8.41 | 0.0235325 |
| 10000 | 8.36 | 0.0158853 |
| 50000 | 8.30 | 0.0075915 |
| 100000 | 8.28 | 0.0059581 |
| 500000 | 8.23 | 0.0039477 |
| 1000000 | 8.20 | 0.0032033 |

TABLE 23
Dielectric Constant (DK) and Loss (Df) at
23° C. of Cold-sintered NMO with 40% PP

| Freq | Avg DK | Avg Df |
|---|---|---|
| (Hz) | (5 samples) | (5 samples) |
| 20 | 14.63 | 0.1605810 |
| 50 | 13.82 | 0.1507280 |
| 100 | 12.35 | 0.0920354 |
| 500 | 11.45 | 0.1191295 |
| 1000 | 10.85 | 0.1098190 |
| 5000 | 9.89 | 0.0646595 |
| 10000 | 9.69 | 0.0443184 |
| 50000 | 9.50 | 0.0169488 |
| 100000 | 8.34 | 0.0090982 |
| 500000 | 9.39 | 0.0054057 |
| 1000000 | 9.34 | 0.0038784 |

TABLE 24
Dielectric Constant (DK) and Loss (Df) at
23° C. of Cold-sintered NMO with 50% PP

| Freq | Avg DK | Avg Df |
|---|---|---|
| (Hz) | (5 samples) | (5 samples) |
| 20 | 17.18 | 0.2716560 |
| 50 | 15.42 | 0.2169505 |
| 100 | 14.06 | 0.2022480 |
| 500 | 12.02 | 0.1529900 |
| 1000 | 11.28 | 0.1402095 |
| 5000 | 9.96 | 0.0927354 |
| 10000 | 9.64 | 0.0667626 |
| 50000 | 9.32 | 0.0265499 |
| 100000 | 7.99 | 0.0171461 |
| 500000 | 9.16 | 0.0083224 |
| 1000000 | 9.10 | 0.0063016 |

TABLE 25
Dielectric Constant (DK) and Loss (Df) at
60° C. of Cold-sintered NMO with 10% PP

| Freq | Avg DK | Avg Df |
|---|---|---|
| (Hz) | (5 samples) | (5 samples) |
| 20 | 14.97 | 0.1094942 |
| 50 | 14.55 | 0.1121265 |
| 100 | 13.98 | 0.0654994 |
| 500 | 13.39 | 0.0355127 |
| 1000 | 13.23 | 0.0264358 |
| 5000 | 13.03 | 0.0122739 |
| 10000 | 12.98 | 0.0088674 |
| 50000 | 12.92 | 0.0045491 |
| 100000 | 11.91 | 0.0007961 |
| 500000 | 12.84 | 0.0030133 |
| 1000000 | 12.79 | 0.0024820 |

TABLE 26
Dielectric Constant (DK) and Loss (Df) at
60° C. of Cold-sintered NMO with 20% PP

| Freq | Avg DK | Avg Df |
|---|---|---|
| (Hz) | (5 samples) | (5 samples) |
| 20 | 13.75 | 2.1634655 |
| 50 | 14.69 | 0.1075225 |
| 100 | 11.96 | 0.1978298 |
| 500 | 12.18 | 0.0739081 |
| 1000 | 11.56 | 0.0466494 |
| 5000 | 11.12 | 0.0427880 |
| 10000 | 10.96 | 0.0295827 |
| 50000 | 10.80 | 0.0112056 |
| 100000 | 9.92 | 0.0032415 |
| 500000 | 10.72 | 0.0040694 |
| 1000000 | 10.67 | 0.0030861 |

TABLE 27
Dielectric Constant (DK) and Loss (Df) at
60° C. of Cold-sintered NMO with 30% PP

| Freq | Avg DK | Freq |
|---|---|---|
| (Hz) | (5 samples) | (Hz) |
| 20 | 99.56 | 20 |
| 50 | 27.60 | 50 |
| 100 | 17.56 | 100 |
| 500 | 12.80 | 500 |
| 1000 | 11.84 | 1000 |
| 5000 | 10.94 | 5000 |
| 10000 | 10.70 | 10000 |
| 50000 | 10.42 | 50000 |
| 100000 | 9.47 | 100000 |
| 500000 | 10.30 | 500000 |
| 1000000 | 10.25 | 1000000 |

TABLE 28
Dielectric Constant (DK) and Loss (Df) at
60° C. of Cold-sintered NMO with 40% PP

| Freq | Avg DK | Avg Df |
|---|---|---|
| (Hz) | (5 samples) | (5 samples) |
| 20 | 14.52 | 0.3221965 |
| 50 | 12.92 | 0.2634095 |
| 100 | 12.33 | 0.2102550 |
| 500 | 10.60 | 0.1570525 |
| 1000 | 9.94 | 0.1519185 |
| 5000 | 8.53 | 0.1315745 |
| 10000 | 8.07 | 0.1088280 |
| 50000 | 7.51 | 0.0502866 |
| 100000 | 7.41 | 0.0338395 |
| 500000 | 7.29 | 0.0138252 |
| 1000000 | 7.24 | 0.0098035 |

TABLE 29
Dielectric Constant (DK) and Loss (Df) at
60° C. of Cold-sintered NMO with 50% PP

| Freq | Avg DK | Avg Df |
|---|---|---|
| (Hz) | (5 samples) | (5 samples) |
| 20 | 23.71 | 0.5855770 |
| 50 | 19.54 | 0.4299630 |
| 100 | 17.36 | 0.3420770 |
| 500 | 14.05 | 0.2138205 |
| 1000 | 13.05 | 0.1853420 |
| 5000 | 11.15 | 0.1475280 |
| 10000 | 10.47 | 0.1280215 |
| 50000 | 9.53 | 0.0651476 |
| 100000 | 8.08 | 0.0472994 |
| 500000 | 9.15 | 0.0174127 |
| 1000000 | 9.07 | 0.0120109 |

TABLE 30
Dielectric Constant (DK) and Loss (Df) at
120° C. of Cold-sintered NMO with 10% PP

| Freq | Avg DK | Avg Df |
|---|---|---|
| (Hz) | (5 samples) | (5 samples) |
| 20 | 22.63 | 0.4414705 |
| 50 | 19.05 | 0.3401225 |
| 100 | 16.97 | 0.2681000 |
| 500 | 14.77 | 0.1245875 |
| 1000 | 14.28 | 0.0909688 |
| 5000 | 13.55 | 0.0454969 |
| 10000 | 13.36 | 0.0328505 |
| 50000 | 13.12 | 0.0140562 |
| 100000 | 12.08 | 0.0054148 |
| 500000 | 12.99 | 0.0047229 |
| 1000000 | 12.93 | 0.0035767 |

TABLE 31
Dielectric Constant (DK) and Loss (Df) at
120° C. of Cold-sintered NMO with 20% PP

| Freq | Avg DK | Avg Df |
|---|---|---|
| (Hz) | (5 samples) | (5 samples) |
| 20 | 22.10 | 0.4817960 |
| 50 | 18.04 | 0.3593455 |
| 100 | 16.22 | 0.2771660 |
| 500 | 14.00 | 0.1389650 |
| 1000 | 13.46 | 0.1090170 |
| 5000 | 12.42 | 0.0833444 |
| 10000 | 11.98 | 0.0759684 |
| 50000 | 11.23 | 0.0438725 |
| 100000 | 10.22 | 0.0267474 |
| 500000 | 10.92 | 0.0106487 |
| 1000000 | 10.86 | 0.0069854 |

TABLE 32
Dielectric Constant (DK) and Loss (Df) at
120° C. of Cold-sintered NMO with 30% PP

| Freq | Avg DK | Avg Df |
|---|---|---|
| (Hz) | (5 samples) | (5 samples) |
| 20 | 20.20 | 0.4502955 |
| 50 | 17.21 | 0.3129600 |
| 100 | 15.71 | 0.2402535 |
| 500 | 13.85 | 0.1257775 |
| 1000 | 13.33 | 0.1051484 |
| 5000 | 12.21 | 0.0879862 |
| 10000 | 11.74 | 0.0814823 |
| 50000 | 10.92 | 0.0489477 |
| 100000 | 9.85 | 0.0316887 |
| 500000 | 10.58 | 0.0122183 |
| 1000000 | 10.52 | 0.0080223 |

TABLE 33
Dielectric Constant (DK) and Loss (Df) at
120° C. of Cold-sintered NMO with 40% PP

| Freq | Avg DK | Avg Df |
|---|---|---|
| (Hz) | (5 samples) | (5 samples) |
| 20 | 25.53 | 0.6927955 |
| 50 | 20.75 | 0.5006455 |
| 100 | 18.24 | 0.3880650 |
| 500 | 14.86 | 0.2140525 |
| 1000 | 13.93 | 0.1756270 |
| 5000 | 12.20 | 0.1389285 |
| 10000 | 11.50 | 0.1324180 |
| 50000 | 10.16 | 0.0932620 |
| 100000 | 8.71 | 0.0731643 |
| 500000 | 9.47 | 0.0261949 |
| 1000000 | 9.38 | 0.0164824 |

TABLE 34
Dielectric Constant (DK) and Loss (Df) at
120° C. of Cold-sintered NMO with 50% PP

| Freq | Avg DK | Freq |
|---|---|---|
| (Hz) | (5 samples) | (Hz) |
| 20 | 34.57 | 20 |
| 50 | 25.44 | 50 |
| 100 | 21.51 | 100 |
| 500 | 16.09 | 500 |
| 1000 | 14.71 | 1000 |
| 5000 | 12.45 | 5000 |
| 10000 | 11.67 | 10000 |
| 50000 | 10.16 | 50000 |
| 100000 | 8.49 | 100000 |
| 500000 | 9.33 | 500000 |
| 1000000 | 9.22 | 1000000 |

Table 35 below shows the Weibull breakdown strength (commonly referred to as the scale factor or a) and slope (commonly referred to as β) of the best fit line. The 10% PP-NMO and 40% PP-NMO samples had the worst R̂2 values in the 0.77-0.82 range with all other bulk ceramic and polymer-ceramic composite samples having an R̂2 best fit value of >0.90.

TABLE 35
ASTMD-149 Weibull breakdown strength and slope of best fit line
of bulk NMO and Cold-sintered NMO-PP and NMO-PEI composites

| | Characteristic Breakdown | Slope |
|---|---|---|
| | Field (V/um) (α) | (β) |
| 10% PP/90% NMO | 5.08 | 8.21 |
| 20% PP/80% NMO | 4.68 | 12.78 |
| 30% PP/70% NMO | 3.76 | 18.12 |
| 40% PP/60% NMO | 2.20 | 10.76 |
| 50% PP/50% NMO | 1.95 | 16.15 |
| NMO (Bulk) | 2.19 | 12.25 |
| 10% PEI-NMO-120 C. | 2.28 | 7.14 |
| 10% PEI-NMO-240 C. | 3.35 | 12.76 |

The 10% PP-NMO sample had the highest breakdown strength out of every sample tested. Increasing the loading level of PP in NMO was shown to decrease the breakdown strength with the 50-50 blend equating to the bulk NMO result. The 10% PEI-NMO composite made at 120 C had a similar breakdown strength to the bulk NMO whereas the sample produced at 240 C had a slight increase versus the bulk.

### Experimental Example 9: Coefficient of Thermal Expansion of Cold-Sintered Composites

The coefficient of thermal expansion (CTE) was measured using a TA instruments thermal mechanical analyzer TMA Q400 and the data was analyzed using Universal Analysis V4.5A from TA instruments.

Samples measuring 13 mm round diameter, 2 mm thickness pellets were re-shaped to fit the TMA Q400 equipment.

A sample, once placed in the TMA Q400, was heated to 150° C. (@20° C./min) at which point the moisture and stress should be relieved and then cooled to −80° C. (@20° C./min) to start the actual CTE measurement. From −80° C. the sample was heated to 150° C. at 5° C. per minute at which point the displacement was measured as a function of temperature.

The measurement data was then loaded into the analysis software and the CTE was calculated using the Alpha x1-X2 method. The method measures the dimension change from temperature T1 to temperature T2 and transforms the dimension change to a CTE value with the following equation:

$$CTE ( μ m / ( m * ° C . ) ) = \frac{Δ L}{Δ T * L 0}$$

where:
ΔL=change in length (μm)
ΔT=change in temperature (° C.)
L0=sample length (m)

The CTE of three polymers in LMO cold sintered samples, in varying levels, were tested with the TMA Q400. The results are presented in Table 36 below.

TABLE 36
CTE of LMO/PEI, LMO/PS and LMO/polyester
cold sintered composites

| | CTE (μm/(m*K)) | | |
|---|---|---|---|
| | −40° C. to | 23° C. to | −40° C. to |
| Sample | 40° C. | 80° C. | 125° C. |
| Bulk LMO | 11.6 | 13.1 | 13.0 |
| LMO/20 vol % PEI | 14.5 | 16.9 | 15.3 |
| LMO/40 vol % PEI | 19.9 | 22.4 | 22.1 |
| LMO/60 vol % PEI | 28.4 | 31.9 | 30.7 |
| LMO/80 vol % PEI | 38.1 | 43.1 | 41.1 |
| 100% PEI (datasheet value −20° C. | 54 | 54 | 54 |
| to 150° C.) | | | |
| LMO/5 wt % (13.8 vol %) | 12.0 | 14.3 | NA |
| Polystyrene powder | | | |
| LMO/10 wt % (22.3 vol %) | 15.9 | 17.6 | 16.9 |
| Polyester powder | | | |

### Experimental Example 10: Effects of Cold Sintering Temperature on Mechanical Properties of LMO/PEI Composite

Diametral Compression

In the diametral compression test method, a circular disk is compressed along its diameter by two flat metal plates. The compression along the diameter creates a maximum tensile stress perpendicular to the loading direction in the mid-plane of the specimen [see ref. J J Swab et at, Int J Fract (2011) 172: 187-192]. The fracture strength (σ_{f}) of the ceramic can be calculated by

$${σ}_{f} = \frac{2 P}{π D t}$$

where P is the fracture load, D is the disk diameter and t is the disk thickness.

All tests were conducted on an ElectroPlus™ E3000 All-electric dynamic test instrument (Instron) with a 1000 N load cell at room temperature. The specimens were mounted between two flat metal plates and a small pre-load of 5 N was applied. Diametral compression tests were conducted under displacement control (0.5 mm/min), and time, compressive displacement and load data was captured at 250 Hz.

Prior to testing, all specimens were speckled using black spray paint. During diametral compression, sequential images of the speckled surface were captured with INSTRON video extensometer AVE (Fujinon 35 mm) at a frequency of 50 Hz. Post test, all images were analyzed using the DIC replay software (Instron) to generate full-field strain maps. A virtual strain gage (6 mm×3 mm) was inserted in the mid-plane of each specimen and transverse strain (εₓ) was calculated. The fracture strain (ε_{f}) was calculated at the maximum load.

A. Preparation of LMO sample. 2 g of LMO powder was added to a mortar, wherein 100 μL/g de-ionized water was added. The resultant mixture was then ground to a paste-like consistency using a pestle. The substance was added to the stainless steel die and pressed into a ceramic pellet at 268 MPa pressure and 150° C. temperature for 30 min.

B. LMO/PEI composite sample. 2 g of PEI (ULTEM™ 1010; average particle size Dv50=15.4 μm; Molecular weight=51000 g/mol; Molecular number=21000; Tg=218° C.) and LMO powder were added to a mortar, wherein a 100 μL/g de-ionized water was added. The resultant mixture was then ground to a paste-like consistency using a pestle. The substance was added to the stainless steel die and pressed into a ceramic pellet at 268 MPa pressure and 150, 180, 200 and 240° C. temperature for 30 min. One pellet was made for each temperature. The mechanical properties obtained from the diametral compression test are shown below in Table 37. Molecular weights obtained from gel permeation chromatography (GPC) analysis are listed in Table 38. The molecular weight of ULTEM 1010 is maintained up to a temperature of 180° C., after which it drops, suggesting degradation of ULTEM 1010 over a temperature of 180° C.

TABLE 37
Summary of mechanical properties for LMO/PEI
composite sintered at different temperatures

| | | | Tem- | Num- | | % | | % |
|---|---|---|---|---|---|---|---|---|
| LMO | PEI | PEI | per- | ber | | Change | | Change |
| vol | vol | wt | ature | of | σf | vs | εf | vs |
| % | % | % | ° C. | pellets | (MPa) | LMO | (%) | LMO |
| 100 | 0 | 0 | 150 | 1 | 5.40 | 0 | 0.042 | 0 |
| 90 | 10 | 4.4 | 150 | 1 | 6.24 | +15.5 | 0.084 | +100 |
| 90 | 10 | 4.4 | 180 | 1 | 5.81 | +7.6 | 0.118 | +181 |
| 90 | 10 | 4.4 | 200 | 1 | 4.88 | −9.6 | 0.027 | −36 |
| 90 | 10 | 4.4 | 240 | 1 | 6.81 | +26 | 0.086 | +105 |

TABLE 38
Summary of molecular weights for LMO/PEI
composite measured via GPC.

| LMO | PEI | PEI | Temperature | Number | Mn | Mw |
|---|---|---|---|---|---|---|
| vol % | vol % | wt % | ° C. | of pellets | (g/mol) | (g/mol) |
| 90 | 10 | 4.4 | 150 | 1 | 13237 | 45702 |
| 90 | 10 | 4.4 | 180 | 1 | 17569 | 47084 |
| 90 | 10 | 4.4 | 200 | 1 | 8320 | 32911 |
| 90 | 10 | 4.4 | 220 | 1 | 4997 | 22972 |
| 90 | 10 | 4.4 | 240 | 1 | 2894 | 7006 |

### Experimental Example 11: Effect of Heat Treating at Temperature Higher than the Tg of the Polymer on the Microstructure of LMO/PEI Composite

LMO/PEI composite sample. 2 g of PEI (ULTEM™ 1010; average particle size Dv50=1 μm) filled LMO powder was added to a mortar, wherein a 100 μL/g de-ionized water was added. The resultant mixture was then ground to a paste-like consistency using a pestle. The substance was added to the stainless steel die and pressed into a ceramic pellet at 268 MPa pressure and 120° C. temperature for 30 min. Two pellets were made each with 10 vol % ULTEM™ 1010 and 90 vol % LMO. One pellet was placed in an oven at 240° C. for 1 hour. Both pellets were analyzed by molecular weight. GPC results of heat treated and non-heat treated (control) are listed in Table 39. Results showed that unlike cold sintering at 240° C., which resulted in significant drop (>85%) in molecular weight of ULTEM™ 1010, heat aging at 240° C. resulted in less than a 5% change in molecular weight.

TABLE 39
Summary of molecular weight for LMO/PEI composite
measured via GPC.

| | | | | Heat | | |
|---|---|---|---|---|---|---|
| | | | | treated | | |
| LMO | PEI | PEI | Temperature | at | Mn | Mw |
| vol % | vol % | Wt % | ° C. | ° C. | at(g/mol) | (g/mol) |
| 90 | 10 | 4.4 | 120 | — | 20158 | 50424 |
| 90 | 10 | 4.4 | 120 | 240 | 19199 | 47958 |

LMO/PEI composite sample. 2 g of PEI (ULTEM™ 1010; average particle size Dv50=1 μm) filled LMO powder was added to a mortar, wherein a 100 μL/g de-ionized water was added. The resultant mixture was then ground to a paste-like consistency using a pestle. The substance is added to the stainless steel die and pressed into a ceramic pellet at 268 MPa pressure and 120° C. temperature for 30 min. One pellet was made with 40 vol % (21.7 wt %) ULTEM™ 1010 and 60 vol % LMO. The sample was broken in liquid nitrogen and one half was annealed in an oven for 1 hr at 260° C. After annealing, the fractured surface of both halves were imaged under a SEM and compared, demonstrating a clear change in morphology of the polymer particles from spherical morphology at 120° C. to melt-like morphology at 260° C.

### Experimental Example 12: Effects of Drying on the Mechanical Properties of LMO and LMO/PEI Composite

LMO sample. 2 g of LMO powder was added to a mortar, wherein a 100 μL/g de-ionized water was added. The resultant mixture was then ground to a paste-like consistency using a pestle. The substance was added to the stainless steel die and pressed into a ceramic pellet at 268 MPa pressure and 150° C. temperature for 30 min. One pellet was tested as is and the other was dried overnight at 125° C. to remove moisture and then tested under diametral compression.

LMO/PEI composite sample. 2 g of PEI (ULTEM™ 1010; average particle size Dv50=15.4 μm; Molecular weight=51000 g/mol; Molecular number=21000; Tg=218° C.) and LMO powder were added to a mortar, wherein a 100 μL/g de-ionized water was added. The resultant mixture was then ground to a paste-like consistency using a pestle. The substance was added to the stainless steel die and pressed into a ceramic pellet at 268 MPa pressure and 240° C. temperature for 30 min. One pellet was tested as is and the other was dried overnight at 125° C. to remove moisture. The diametral compression test results are shown in Table 40.

TABLE 40
Summary of mechanical properties for pure LMO and
LMO/PEI composite before and after drying at 125° C..

| | | | Tem- | | | % | | % |
|---|---|---|---|---|---|---|---|---|
| | | | per- | Dried | | Change | | Change |
| LMO | PEI | PEI | ature | at | σf | vs No | εf | vs No |
| vol % | vol % | wt % | ° C. | 125° C. | (MPa) | Dry | (%) | Dry |
| 100 | 0 | 0 | 150 | No | 5.40 | 0 | 0.042 | 0 |
| 100 | 0 | 0 | 150 | Yes | 9.69 | +79 | 0.078 | +86 |
| 80 | 20 | 9.5 | 240 | No | 6.82 | — | 0.054 | — |
| 80 | 20 | 9.5 | 240 | Yes | 9.98 | +46 | 0.074 | +37 |

### Experimental Example 13: Effects of Sintering Pressure on the Mechanical Properties of LMO/PEI Composite

LMO/PEI composite sample. 2 g of PEI (ULTEM™ 1010; average particle size Dv50=15.4 μm; Molecular weight=51000 g/mol; Molecular number=21000; Tg=218° C.) filled LMO powder was added to a mortar, wherein 100 μL/g de-ionized water was added. The resultant mixture was then ground to a paste-like consistency using a pestle. The substance was added to the stainless steel die and pressed into a ceramic pellet at 134 MPa, 268 MPa or 402 MPa pressure and 240° C. temperature for 30 min. 4 pellets were made at 134 MPa pressure, 2 pellets were made at 268 MPa, and 3 pellets were made at 402 MPa pressure. All pellets were dried overnight at 125° C. in an oven. The diametral compression test results are shown in Table 41. It was demonstrated that the LMO/PEI composite cold sintered at 268 MPa pressure exhibited the highest average fracture stress and fracture strain compared to the samples made at 134 and 402 MPa.

TABLE 41
Summary of mechanical properties for LMO/PEI
composite cold sintered at various pressures.

| | | | Temper- | | Number | | |
|---|---|---|---|---|---|---|---|
| LMO | PEI | PEI | ature | Pressure | of | σf | εf |
| vol % | vol % | Wt % | ° C. | (MPa) | pellets | (MPa) | (%) |
| 90 | 10 | 4.4 | 240 | 134 | 4 | 5.20 | 0.049 |
| 90 | 10 | 4.4 | 240 | 268 | 2 | 7.97 | 0.069 |
| 90 | 10 | 4.4 | 240 | 402 | 3 | 4.33 | 0.022 |

### Experimental Example 14: Effects of Change in Polymer Vol % on the Mechanical Properties of LMO/PEI Composite

LMO sample. 2 g of LMO powder was added to a mortar, wherein 100 μL/g de-ionized water was added. The resultant mixture was then ground to a paste-like consistency using a pestle. The substance was added to the stainless steel die and pressed into a ceramic pellet at 268 MPa pressure and 150° C. temperature for 30 min. The LMO pellet was dried overnight at 125° C. in an oven and tested under diametral compression.

LMO/PEI composite sample. 2 g of PEI (ULTEM™ 1010; average particle size Dv50=15.4 μm; Molecular weight=51000 g/mol; Molecular number=21000; Tg=218° C.) filled LMO powder was added to a mortar, wherein 100 μL/g de-ionized water was added. The resultant mixture was then ground to a paste-like consistency using a pestle. The substance was added to the stainless steel die and pressed into a ceramic pellet at 268 MPa pressure and 240° C. temperature for 30 min. Pellets were dried overnight at 125° C. in an oven. The diametral compression test results are shown in Table 42.

TABLE 42
Summary of mechanical properties for LMO/PEI
composite at 20 and 40 vol % of PEI.

| | | | Tem- | | | % | | % |
|---|---|---|---|---|---|---|---|---|
| LMO | PEI | PEI | per- | Dried | | Change | | Change |
| vol | vol | Wt | ature | at | σf | vs | εf | vs |
| % | % | % | ° C. | 125° C. | (MPa) | LMO | (%) | LMO |
| 100 | 0 | 0 | 150 | Yes | 9.69 | 0 | 0.078 | 0 |
| 80 | 20 | 9.5 | 240 | Yes | 9.98 | +3 | 0.074 | −5 |
| 60 | 40 | 21.7 | 240 | Yes | 15.31 | +58 | 0.240 | +208 |

### Experimental Example 15: Effects of Polymer Particle Size on the Mechanical Properties of LMO/PEI Composite

LMO sample. 2 g of LMO powder was added to a mortar, wherein 100 μL/g de-ionized water was added. The resultant mixture was then ground to a paste-like consistency using a pestle. The substance is added to the stainless steel die and pressed into a ceramic pellet at 268 MPa pressure and 150° C. temperature for 30 min. The LMO pellet was dried overnight at 125° C. in an oven and tested under diametral compression.

LMO/PEI composite sample. 2 g of PEI (ULTEM™ 1010) and LMO powder were added to a mortar, wherein 100 μL/g de-ionized water was added. PEI with 2 different average particle sizes were used. Large PEI is defined as spherical particles with average particle diameter Dv50=15.4 μm; Dn50=1.8 μm. Small PEI is defined as spherical particles with average particle diameter Dv50=1.4 μm; Dn50=18.7 nm. The small particles were synthesized at SABIC. The resultant mixture was then ground to a paste-like consistency using a pestle. The substance was added to the stainless steel die and pressed into a ceramic pellet at 268 MPa pressure and 180° C. temperature for 30 min. Pellets were dried overnight at 125° C. in an oven. The diametral compression test results are shown in Table 43.

TABLE 43
Summary of mechanical properties for LMO/PEI
composite made using two different average particle size of PEI.

| | | | Tem- | PEI Particle | | % | | % |
|---|---|---|---|---|---|---|---|---|
| LMO | PEI | PEI | per- | size | | Change | | Change |
| vol | vol | Wt | ature | average | σf | vs | εf | vs |
| % | % | % | ° C. | (Dv50, μm) | (MPa) | LMO | (%) | LMO |
| 100 | 0 | 0 | 150 | — | 9.69 | 0 | 0.078 | 0 |
| 80 | 20 | 9.5 | 180 | 15.4 | 11.86 | +22 | 0.104 | +33 |
| 80 | 20 | 9.5 | 180 | 1.4 | 17.18 | +77 | 0.159 | +104 |

### Experimental Example 16: Fracture Stress and Fracture Strain for LMO/PEI Composite

2 g of PEI (ULTEM™ 1010; average particle size Dv50=1 μm) filled LMO powder was added to a mortar, wherein a 5 μL/g de-ionized water was added. The resultant mixture was then ground to a paste-like consistency using a pestle. The substance is added to the stainless steel die and pressed into a ceramic pellet with high density. Experiments were conducted with 134.0 MPa at 120° C. for 30 min. Fracture stress and fracture strain obtained from the diametral compression test for pure LMO and LMO/PEI composite are listed in Table 44. The average fracture stress and fracture strain of LMO/PEI composite improved by 14% and 82%, respectively versus pure LMO.

TABLE 44
Fracture stress and fracture strain for LMO/PEI
composite made via cold sintering.

| | | Num- | | | % | | % |
|---|---|---|---|---|---|---|---|
| LMO | PEI | ber | Dried | | Change | | Change |
| vol | vol | of | at | σ_{f} | vs | ε_{f} | vs |
| % | % | pellets | 125° C. | (MPa) | LMO | (%) | LMO |
| 100 | 0 | 3 | No | 5.67 ± 2.62 | 0 | 0.069 ± 0.026 | 0 |
| 60 | 40 | 3 | No | 6.45 ± 0.19 | +14 | 0.126 ± 0.012 | +82 |

### Experimental Example 17: LMO/PPO Composite Via Cold Sintering

2 g of PPO (cryo-milled SA90) filled LMO powder was added to a mortar, wherein a 100 μL/g de-ionized water was added. The resultant mixture was then ground to a paste-like consistency using a pestle. The substance was added to the stainless steel die and pressed into a ceramic pellet. Experiments were conducted with 268.0 MPa at 120, 150, 180, 200 and 240° C. for 30 min. All pellets were dried at 125° C. in an oven overnight prior to mechanical testing. Fracture stress and fracture strain obtained from the diametral compression test for pure LMO and LMO/PPO composite are listed in Table 44.

TABLE 44
Fracture stress and fracture strain for LMO-PPO
composite made via cold sintering.

| | | Num- | | | % | | % |
|---|---|---|---|---|---|---|---|
| LMO | PPO | ber | | | Change | | Change |
| vol | vol | of | Temp | σ_{f} | vs | ε_{f} | vs |
| % | % | pellets | C | (MPa) | LMO | (%) | LMO |
| 100 | 0 | 1 | 150 | 9.69 | 0 | 0.078 | 0 |
| 80 | 20 | 1 | 120 | 7.60 | −22 | 0.045 | −42 |
| 80 | 20 | 1 | 150 | 8.22 | −15 | 0.063 | −19 |
| 80 | 20 | 1 | 180 | 7.89 | −19 | 0.099 | +27 |
| 80 | 20 | 1 | 200 | 6.22 | −36 | 0.032 | −59 |
| 80 | 20 | 1 | 240 | 5.10 | −47 | 0.124 | +59 |

### Experimental Example 18: LMO/Branched-PEI Composite Via Cold Sintering

2 g of cryo-milled branched PEI (33 kDa with 0.3 mol % of branching agent TAPE) filled LMO powder was added to a mortar, wherein a 50 μL/g de-ionized water was added. The resultant mixture was then ground to a paste-like consistency using a pestle. The substance is added to the stainless steel die and pressed into a ceramic pellet with high density. Experiments were conducted with 268.0 MPa at 150° C. and 240° C. for 30 min. All pellets were dried at 125° C. in an oven overnight prior to mechanical testing. Fracture stress and fracture strain obtained from the diametral compression test for pure LMO and LMO/Branched-PEI composite are listed in Table 45.

TABLE 45
Fracture stress and fracture strain for LMO-Branched-
PEI composite made via cold sintering.

| | | | | | % | | % |
|---|---|---|---|---|---|---|---|
| | Branched | Number | | | Change | | Change |
| LMO | PEI | of | Temp | σ_{f} | vs | ε_{f} | vs |
| vol % | vol % | pellets | C | (MPa) | LMO | (%) | LMO |
| 100 | 0 | 1 | 150 | 9.69 | 0 | 0.078 | 0 |
| 90 | 10 | 1 | 150 | 6.09 | −37 | 0.05 | −36 |
| 90 | 10 | 1 | 240 | 8.25 | −15 | 0.093 | 19 |

### Experimental Example 19: LMO/PC Composite Via Cold Sintering

2 g of an amorphous cryo-ground PC (LEXAN™ 100 resin) filled LMO powder was added to a mortar, wherein a 100 μL/g de-ionized water was added. The resultant mixture was then ground to a paste-like consistency using a pestle. The substance is added to the stainless steel die and pressed into a ceramic pellet with high density. Experiments were conducted with 268.0 MPa at 150° C. for 30 min. All pellets were dried at 125° C. in an oven overnight prior to mechanical testing. Fracture stress and fracture strain obtained from the diametral compression test for pure LMO and LMO/PC composite are listed in Table 46. The average fracture stress and fracture strain of LMO/PC composite sintered at 150° C. improved by 15.5% and 5%, respectively versus pure LMO.

TABLE 46
Fracture stress and fracture strain for LMO-
amorphous PC composite made via cold sintering.

| | | | | | (%) | | (%) |
|---|---|---|---|---|---|---|---|
| | | Number | Temper- | | Change | | Change |
| LMO | PC | of | ature | σ_{f} | vs | ε_{f} | vs |
| vol % | vol % | pellets | (° C.) | (MPa) | LMO | (%) | LMO |
| 100 | 0 | 1 | 150 | 9.69 | 0 | 0.078 | 0 |
| 100 | 0 | 1 | 180 | 8.98 | — | — | — |
| 90 | 10 | 1 | 150 | 11.20 | +15.5 | 0.082 | +5.1 |
| 90 | 10 | 1 | 180 | 9.17 | +2.1 | — | — |

### Experimental Example 20: Multi-Specimen Cold Sintering

LMO samples. 6 g of LMO powder was added to a mortar, wherein a 100 μL/g de-ionized water was added. The resultant mixture was then ground to a paste-like consistency using a pestle. 2 g of the LMO de-ionized water mixture was added to the stainless steel die with a stainless steel die pellet above and below the mixture.

Another 2 g of the LMO de-ionized water mixture was added to the stainless steel die and another stainless steel die pellet was inserted on the top.

Finally, another 2 g of the LMO de-ionized water mixture was added to the stainless steel die and a stainless steel die pellet was inserted on the top. Between each sample and the steel die pellet a 13 mm diameter and 125 micron thick film of polyimide (Dupont™ Kapton® HN) was inserted. The entire stack was pressed at 268 MPa pressure and 180° C. temperature for 30 min. The resulting density of each pellet is listed in Table 47 and compared to a single LMO pellet made at the same temperature.

TABLE 47
Density comparison between single pellet
versus multiple cold sintered pellets.

| | | Single | | |
|---|---|---|---|---|
| LMO | Temperature | or | Specimen | Density |
| vol % | ° C. | Multiple | # | (%) |
| 100 | 180 | Single | 1 | 99.6 |
| 100 | 180 | Multiple | 1 | 98.6 |
| 100 | 180 | Multiple | 2 | 97.9 |
| 100 | 180 | Multiple | 3 | 97.9 |

### Further Examples

Additional examples listed below further illustrate the processes and the cold-sintered ceramic polymer composites of the invention.

Example 1 is a cold-sintered ceramic polymer composite that is made by a process comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline, or a glass transition temperature (T_{g}), if the polymer is amorphous, that is less than T₁.

Example 2 includes example 1 wherein the polymer is not polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion).

Example 3 is a cold-sintered ceramic polymer composite that is made by a process comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline, or a glass transition temperature (T_{g}), if the polymer is amorphous, that is less than T₁; and
wherein the polymer is a branched polymer.

Example 4 includes any one of examples 1-3, wherein T₁ is no greater than 100° C. above the boiling point of the solvent.

Example 5 includes any one of examples 1-4, wherein the mixture further comprises at least one polymer (P₂) that has a Tₘ, if the polymer is crystalline or semi-crystalline, or a T_{g}, if the polymer is amorphous, that is greater than T₁.

Example 6 includes any one of examples 1-5, wherein the process further comprises:
(c) subjecting the cold-sintered ceramic polymer composite to a temperature T₂ that is greater than Tₘ or T_{g}.

Example 6-A includes Example 6, wherein T₂ is greater than T₁.

Example 7 includes any one of examples 1-6, wherein the at least one polymer (P₁) is selected from the group consisting of polyacetylenes, polypyrroles, polyanilines, poly(p-phenylene vinylene), poly(3-alkylthiophenes), polyacrylonitrile, poly(vinylidene fluoride), polyesters, polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes, polyamides, acrylics, co-polymers thereof, and blends thereof.

Example 8 includes any one of examples 1-6, wherein the weight percentage of the inorganic compound in the mixture is about 50 to about 99% (w/w) based upon the total weight of the mixture.

Example 9 includes any one of examples 1-8, wherein the weight percentage of the at least one polymer in the mixture is about 1 to about 50% (w/w) based upon the total weight of the mixture.

Example 10 includes any one of examples 1-9, wherein the solvent comprises water, an alcohol, an ester, a ketone, a dipolar aprotic solvent, or combinations thereof.

Example 11 includes any one of examples 1-10, wherein the solvent comprises at least 50% water by weight, based upon the total weight of the solvent.

Example 12 includes any one of examples 1-11, wherein the solvent further comprises an inorganic acid, an organic acid, an inorganic base, or organic base.

Example 13 includes any one of examples 1-12, wherein the process further comprises subjecting the cold-sintered ceramic polymer composite to a post-curing or finishing step.

Example 14 includes example 13, wherein the post-curing or finishing step is annealing or machining the cold-sintered ceramic polymer composite.

Example 15 includes any one of examples 1-14, wherein the process further includes one or more steps selected from injection molding, autoclaving, and calendering.

Example 16 includes any one of examples 1-15, wherein the subjecting step (b) is performed at a temperature (T₁) between about 50° C. to about 300° C.

Example 17 includes example 16, wherein the temperature (T₁) is between about 70° C. to about 250° C.

Example 18 includes example 17, wherein the temperature (T₁) is between about 100° C. to about 200° C.

Example 19 includes any one of examples 1-18, wherein the mixture further comprises at least one of a carbon-based material and an elemental metal.

Example 20 includes example 19, wherein the carbon-based material is at least one selected from the group consisting of graphite, nanotubes, graphene, carbon black, fullerenes, amorphous carbon, pitch, and tar.

Example 21 includes any one of examples 1-20, wherein the cold-sintered ceramic polymer composite has a relative density of at least 90%.

Example 22 includes any one of examples 1-21 wherein the cold-sintered ceramic polymer composite has a relative density of at least 95%.

Example 23 is a process for making a cold-sintered ceramic polymer composite, comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline, or a glass transition temperature (T_{g}), if the polymer is amorphous, that is less than T₁.

Example 24 includes example 23, wherein the polymer is not polycarbonate, polyetherether ketone, polyetherimide, polyethersulfone, polyethylene, polypropylene, polystyrene, polytetrafluoroethylene, polyurethanes, polyvinyl chloride, polyvinylidene difluoride, and sulfonated tetrafluoroethylene (Nafion).

Example 25 is a process for making a cold-sintered ceramic polymer composite, comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline, or a glass transition temperature (T_{g}), if the polymer is amorphous, that is less than T₁; and
wherein the polymer is a branched polymer.

Example 26 includes any one of examples 23-25, wherein T₁ is no greater than 100° C. above the boiling point of the solvent.

Example 27 includes any one of examples 23-26, wherein the mixture further comprises at least one polymer (P₂) that has a Tₘ, if the polymer is crystalline or semi-crystalline, or a T_{g}, if the polymer is amorphous, that is greater than T₁.

Example 28 includes any one of examples 23-27, wherein the process further comprises:
(c) subjecting the cold-sintered ceramic polymer composite to a temperature T₂ that is greater than Tₘ or T_{g}.

Example 28-A includes Example 28, wherein T₂ is greater than T₁.

Example 29 includes any one of examples 23-28, wherein the at least one polymer (P₁) is selected from the group consisting of polyacetylenes, polypyrroles, polyanilines, poly(p-phenylene vinylene), poly(3-alkylthiophenes), polyacrylonitrile, poly(vinylidene fluoride), polyesters, polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes, polyamides, acrylics, co-polymers thereof, and blends thereof.

Example 30 includes any one of examples 23-29, wherein the weight percentage of the inorganic compound in the mixture is about 50 to about 99% (w/w) based upon the total weight of the mixture.

Example 31 includes any one of examples 23-30, wherein the weight percentage of the at least one polymer in the mixture is about 1 to about 50% (w/w) based upon the total weight of the mixture.

Example 32 includes any one of examples 23-31, wherein the solvent comprises water, an alcohol, an ester, a ketone, a dipolar aprotic solvent, or combinations thereof.

Example 33 includes any one of examples 23-32, wherein the solvent comprises at least 50% water by weight, based upon the total weight of the solvent.

Example 34 includes any one of examples 23-33, wherein the solvent further comprises an inorganic acid, an organic acid, an inorganic base, or organic base.

Example 35 includes any one of examples 23-34, wherein the process further comprises subjecting the cold-sintered ceramic polymer composite to a post-curing or finishing step.

Example 36 includes example 35, wherein the post-curing or finishing step is annealing or machining the cold-sintered ceramic polymer composite.

Example 37 includes any one of examples 23-36, wherein the process further includes one or more steps selected from injection molding, autoclaving, and calendering.

Example 38 includes any one of examples 23-37, wherein the subjecting step (b) is performed at a temperature (T₁) between about 50° C. to about 300° C.

Example 39 includes example 38, wherein the temperature (T₁) is between about 70° C. to about 250° C.

Example 40 includes example 39, wherein the temperature (T₁) is between about 100° C. to about 200° C.

Example 41 includes any one of examples 23-40, wherein the mixture further comprises at least one of a carbon-based material and an elemental metal.

Example 42 includes example 41, wherein the carbon-based material is at least one selected from the group consisting of graphite, nanotubes, graphene, carbon black, fullerenes, amorphous carbon, pitch, and tar.

Example 43 includes any one of examples 23-42 wherein the cold-sintered ceramic polymer composite has a relative density of at least 90%.

Example 44 includes any one of examples 23-43 wherein the cold-sintered ceramic polymer composite has a relative density of at least 95%.

1. A cold-sintered ceramic polymer composite that is made by a process comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline,
or a glass transition temperature (T_{g}), if the polymer is amorphous, that is less than T₁.

2. (canceled)

3. (canceled)

4. The cold-sintered ceramic polymer composite according to claim 1, wherein T₁ is no greater than 100° C. above the boiling point of the solvent.

5. The cold-sintered ceramic polymer composite according to claim 1, wherein the mixture further comprises at least one polymer (P₂) that has a Tₘ, if the polymer is crystalline or semi-crystalline, or a T_{g}, if the polymer is amorphous, that is greater than T₁.

6. The cold-sintered ceramic polymer composite according to claim 1, wherein the process further comprises:
c. subjecting the cold-sintered ceramic polymer composite to a temperature T₂ that is greater than Tₘ or T_{g}.

7. The cold-sintered ceramic polymer composite according to claim 1, wherein the at least one polymer (P₁) is selected from the group consisting of polyacetylenes, polypyrroles, polyanilines, poly(p-phenylene vinylene), poly(3-alkylthiophenes), polyacrylonitrile, poly(vinylidene fluoride), polyesters, polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes, polyamides, acrylics, co-polymers thereof, and blends thereof.

8. The cold-sintered ceramic polymer composite according to claim 1, wherein the weight percentage of the inorganic compound in the mixture is about 50 to about 99% (w/w) based upon the total weight of the mixture.

9. The cold-sintered ceramic polymer composite according to claim 1, wherein the weight percentage of the at least one polymer in the mixture is about 1 to about 50% (w/w) based upon the total weight of the mixture.

10. (canceled)

11. The cold-sintered ceramic polymer composite according to claim 1, wherein the solvent comprises at least 50% water by weight, based upon the total weight of the solvent.

12. The cold-sintered ceramic polymer composite according to claim 11, wherein the solvent further comprises an inorganic acid, an organic acid, an inorganic base, a metal salt, or organic base.

13.-22. (canceled)

23. A process for making a cold-sintered ceramic polymer composite, comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline,
or a glass transition temperature (T_{g}), if the polymer is amorphous, that is less than T₁.

24. (canceled)

25. A process for making a cold-sintered ceramic polymer composite, comprising:
a. combining at least one inorganic compound in the form of particles having a number average particle size of less than about 30 μm with at least one polymer (P₁) and a solvent in which the inorganic compound is at least partially soluble to obtain a mixture; and
b. subjecting the mixture to a pressure of no more than about 5000 MPa and a temperature (T₁) that is no greater than 200° C. above the boiling point of the solvent (as determined at 1 bar) to obtain the cold-sintered ceramic polymer composite,
wherein the polymer has a melting point (Tₘ), if the polymer is crystalline or semi-crystalline,
or a glass transition temperature (T_{g}), if the polymer is amorphous, that is less than T₁; and
wherein the polymer is a branched polymer.

26. The process according to claim 23, wherein T₁ is no greater than 100° C. above the boiling point of the solvent.

27. The process according to claim 23, wherein the mixture further comprises at least one polymer (P₂) that has a Tₘ, if the polymer is crystalline or semi-crystalline, or a T_{g}, if the polymer is amorphous, that is greater than T₁.

28. The process according to claim 23, wherein the process further comprises:
(c) subjecting the cold-sintered ceramic polymer composite to a temperature T₂ that is greater than Tₘ or T_{g}.

29. The process according to claim 23, wherein the at least one polymer (P₁) is selected from the group consisting of polyacetylenes, polypyrroles, polyanilines, poly(p-phenylene vinylene), poly(3-alkylthiophenes), polyacrylonitrile, poly(vinylidene fluoride), polyesters, polyacrylamides, polytetrafluoroethylene, polytrifluorochloroethylene, polytrifluorochloroethylene, perfluoroalkoxy alkanes, polyaryl ether ketones, polyarylene sulfones, polyaryl ether sulfones, polyarylene sulfides, polyimides, polyamidoimides, polyesterimides, polyhydantoins, polycycloenes, liquid crystalline polymers, polyarylensulfides, polyoxadiazobenzimidazoles, polyimidazopyrolones, polypyrones, polyorganosiloxanes, polyamides, acrylics, co-polymers thereof, and blends thereof.

30. The process according to claim 23, wherein the weight percentage of the inorganic compound in the mixture is about 50 to about 99% (w/w) based upon the total weight of the mixture.

31. The process according to claim 23, wherein the weight percentage of the at least one polymer in the mixture is about 1 to about 50% (w/w) based upon the total weight of the mixture.

32. (canceled)

33. The process according to claim 23, wherein the solvent comprises at least 50% water by weight, based upon the total weight of the solvent.

34. The process according to claim 33, wherein the solvent further comprises an inorganic acid, an organic acid, an inorganic base, or organic base.

35. The process according to claim 23, wherein the process further comprises subjecting the cold-sintered ceramic polymer composite to a post-curing or finishing step.

36.-44. (canceled)
